(19) United States
(12) Patent Application Publication
(10) Pub. No.: US 2026/0240202 A1
(43) Pub. Date: Aug. 20, 2026

(54) MINERAL PROTEINATES FOR USE IN ANIMAL FEEDS, AND METHODS OF MAKING THEREOF

(71) Applicant: Cargill, Incorporated, Wayzata, MN (US)

(72) Inventors: Sonia Tien-ying Han, Minneapolis, MN (US); Keith John Mertz, Blair, NE (US); Michael Arthur Porter, Maple Grove, MN (US); Hadi Nayef Yehia, Beavercreek, OH (US)

(73) Assignee: Cargill, Incorporated, Wayzata, MN (US)

(21) Appl. No.: 19/489,599

(22) PCT Filed: Jun. 28, 2024
(86) PCT No.: PCT/US2024/035940

§ 371 Date: Dec. 3, 2025

Related U.S. Application Data
(60) Provisional application No. 63/510,648, filed on Jun. 28, 2023.

(51) Int. Cl. A23K 20/147; A23K 10/38; A23K 20/20; A23K 50/75

(52) U.S. Cl. CPC A23K 20/147; A23K 10/38; A23K 20/30; A23K 50/75

(57) ABSTRACT

Disclosed herein are nutritional compositions comprising: (i) one or more of trace metals selected from zinc, manganese, cobalt, copper, and chromium and (ii) a milled corn product; wherein up to 75 wt % of the trace metal is chelated or complexed within the milled corn product on a dry weight basis, the amount of trace metal is about 0.025 wt % to about 12 wt % of the nutritional composition product on a dry weight basis, and the amount of protein is about 18 to about 83 wt % of the nutritional composition on a dry weight basis. Also disclosed are methods for making and using the nutritional compositions, animal feeds containing the nutritional compositions, and methods of making and using said animal feeds.

### CROSS-REFERENCE TO RELATED APPLICATIONS

This application claims the benefit of U.S. Provisional Patent Application No. 63/510,648, filed 28 Jun. 2023, which is hereby incorporated by reference in its entirety.

### TECHNICAL FIELD

The disclosure relates to chelated metals that provide trace mineral needs. In particular, the present disclosure relates to chelated metals, methods of making thereof, and their use in animal feed applications.

### BACKGROUND

Proper nutrition, including certain metals, is important for good health. For example, proper nutrition is imperative for maintenance, immunologic response, reproductive efficiency, growth and gain in livestock production. This requirement extends beyond just meeting the dietary requirement for energy and crude protein. Meeting minimum prerequisite levels are imperative for simple animal husbandry, but in many cases can be optimized to provide accelerated productivity. Minerals being inorganic in form are often delivered as complexes in the diet with various amounts of absorption and bioavailability in the animal. Often, minerals (i.e., trace metal ions) need to be overfed as the actual metabolic use in vivo may be a fraction of the availability of some minerals. The remainder of the unused mineral is excreted and, in some cases, may have environmental consequences. Under these scenarios, cost is not optimized due to incomplete use by the animal. In some diets, compounds such as phytic acid may bind the mineral making it unavailable for absorption. Additionally, many of these minerals are in a form that makes them hygroscopic and potentially highly water soluble. When compounded into feeds destined for use in aquaculture the loss of the valuable nutrient can be leached into the water before consumption, resulting in deficiencies in the diet. There is a need for improved products and methods of use thereof for incorporating minerals into feed products.

### BRIEF SUMMARY OF THE INVENTION

This section provides a general summary of the disclosure and is not a comprehensive disclosure of its full scope or all of its features.

In various aspects, the present disclosure provides nutritional compositions comprising: (i) one or more of trace metals selected from zinc, manganese, cobalt, copper, and chromium; and (ii) a milled corn product; wherein up to about 75 weight percent (wt %) of the trace metal is chelated or complexed within the milled corn product on a dry weight basis, and the amount of trace metal is about 0.025 wt % to about 12 wt % of the nutritional composition product on a dry weight basis; the amount of protein is about 18 to about 83 wt % of the nutritional composition on a dry weight basis.

In other aspects, the present disclosure provides methods of producing a metal chelated milled corn product comprising (i) contacting at least one milled corn product with a salt comprising a metal selected from zinc, manganese, cobalt, copper, and chromium in the presence of water to produce the metal chelated milled corn product; and (ii) removing at least a portion of the water from the metal chelated milled corn product; wherein the amount of water is about 26 to about 88 wt % prior to removing at least a portion of water from the metal chelated milled corn product.

In further aspects, the present disclosure provides methods of producing a metal chelated milled corn product comprising: (i) wet milling one or more corn protein-containing materials to produce at least one corn protein concentrate and at least one aqueous stream; (ii) separating the protein concentrate from the aqueous stream; (iii) forming heavy steep water from the aqueous stream; and (iv) contacting at least one of the corn protein concentrate and the heavy steep water with a salt comprising a metal selected from zinc, manganese, cobalt, copper, and chromium to produce the metal chelated milled corn product.

Other aspects of the present disclosure includes methods of providing trace metal nutrients to an animal comprising adding the nutritional composition disclosed herein to an animal feed product.

In yet other aspects, the present disclosure provides animal feeds, methods for feeding animals, and methods for preparing animal feeds. In some aspects, the present disclosure provides an animal feed comprising 0.0001 wt % to 0.8500 wt % of a nutritional composition, the nutritional composition comprising: (i) one or more trace metals selected from zinc, manganese, cobalt, copper, and chromium based on total weight of the animal feed; and (ii) a milled corn product comprising protein; wherein up to about 75 wt % of the trace metal is chelated or complexed within the milled corn product on a dry weight basis; wherein the amount of trace metal is about 250 ppm to about 12 wt % of the nutritional composition product on a dry weight basis; and the amount of protein is about 18 wt % to about 83 wt % of the nutritional composition on a dry weight basis.

In other aspects, the present disclosure provides methods of feeding an animal comprising feeding the animal an animal feed comprising a nutritional composition described herein.

Other aspects of the present disclosure provide a concentrate, premix, or top dress for animals comprising the nutritional composition described herein.

In yet other aspects, the present disclosure includes a complete feed for animals comprising the concentrates, premixes and/or top dresses disclosed herein.

In further aspects, the present disclosure provides making a complete feed, the method comprising: combining the concentrates, premixes, or top dresses described herein with a base animal feed to form the complete feed.

Still other aspects concern increasing the bioavailability of trace nutrients to an animal by adding the mineral proteinates described herein to animal food.

In other aspects, the present disclosure provides food products comprising the nutritional compositions disclosed herein.

The features, functions, and advantages that have been discussed can be achieved independently in various examples or can be combined in yet other examples further details of which can be seen with reference to the following description and drawings.

### BRIEF DESCRIPTION OF THE DRAWINGS

The various advantages of the examples of the present disclosure will become apparent to on skilled in the art by reading the following specification and appended claims, and by referencing the following drawings in which:

FIG. 1A shows PXRD patterns of MinPro #1 Zn-E75 (at 0 and 9.4% Zn inclusion).

FIG. 1B shows PXRD patterns of MinPro #2 Zn-HSW (at 0 and ~9.4% Zn inclusions) on two different carrier (wet E75 cake or dry solvent extracted meal).

FIG. 1C shows PXRD patterns of MinPro #6 Zn-HSW (at 0 and ~9.4% Zn inclusions) on two different carrier (wet E75 cake or dry solvent extracted meal).

FIG. 2A presents SEM-EDS spectra of MinPro #1 Zn-E75 (at 0 and 9.4% Zn inclusion).

FIG. 2B presents SEM-EDS spectra of MinPro #2 Zn-HSW-E75 (at 0 and 9.4% Zn inclusion).

FIG. 2C presents SEM-EDS spectra of MinPro #6 Zn-HSW-E75 (at 0 and 9.4% Zn inclusion).

FIG. 3A presents SEM elemental mapping of MinPro #1 Zn-E75 (at 0 and 9.4% Zn inclusion) showing zinc distribution and colocalized nitrogen.

FIG. 3B presents SEM elemental mapping of MinPro #2 Zn-HSW-E75 (at 0 and 9.4% Zn inclusion) showing zinc distribution and colocalized nitrogen.

FIG. 3C presents SEM elemental mapping of MinPro #6 Zn-HSW-E75 (at 0 and 9.4% Zn inclusion) showing zinc distribution and colocalized nitrogen.

FIG. 4 presents TGA spectra of E75 control (C), Zn-E75 (T1), Zn-E75 (T2), Zn-E75 (T3 (1)), and Zn-E75 (T3 (2)).

FIG. 5 presents DSC spectra of ZnSO₄ salt(S), E75 control (C), Zn-E75 (T1), Zn-E75 (T2), Zn-E75 (T3 (1)), and Zn-E75 (T3 (2)).

FIG. 6 presents DSC spectra of MinPro #1, 2, & 6, controls, and ZnSO₄·7H₂O salt (at 0 and 9.4% Zn inclusion).

FIG. 7 shows a graph of average feed intake by treatment. ^{abc}Bars with different letters were significantly different (P≤0.05). ^{d}Negative control significantly different from Zn supplemented diets regardless of treatment (P≤0.05).

FIG. 8 shows a plot of average weight gain by prototype and inclusion Zn inclusion level. Bars with different letter were significantly different (P≤0.05).

FIG. 9 shows a plot of feed conversion comparison of prototypes fed at different levels. Bars with different letters were significantly different (P≤0.05).

FIG. 10 presents a comparison of Zn prototypes to ZnSO₄ bioavailability. In each group, the first bar is ZnSO₄, the second bar is MinPro-E75 and the third bar is total tibia Zn content.

Accordingly, it is to be understood that the examples of the disclosure herein described are merely illustrative of the application of the principles of the disclosure. Reference herein to details of the illustrated examples is not intended to limit the scope of the claims, which themselves recite those features regarded as essential to the disclosure.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter. One aspect described in conjunction with a particular aspect is not necessarily limited to that aspect and can be practiced with any other aspect(s).

### Definitions

As used herein, the following terms have the following meanings unless expressly stated to the contrary.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

When values are expressed as approximations, by use of the antecedent “about,” it will be understood that the particular value forms another example.

All ranges are inclusive and combinable. In addition, when a range is recited, it is contemplated that all values within the range, including end points, are combinable in all possible combinations.

Unless otherwise specified, percentages are by weight percent (wt %) rather than volume present.

As used herein, the singular forms “a,” “an,” and “the” and similar referents in the context of describing the elements (especially in the context of the following claims) include plural referents unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

Nothing in the cited references teaches or suggests the claimed process. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure, and are not meant to be limiting in any fashion.

In the methods described herein, the acts can be carried out in a specific order as recited herein. Alternatively, in any aspect disclosed herein, specific acts may be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the term “milled corn product” refers to the product of corn milling. In some cases, the corn is wet milled. In other cases, the corn is dry milled. Milled corn products include milled corn product corn protein concentrate, corn protein isolate, fermented corn extractives, corn extractives, corn steep liquor, steep water, gluten slurry, liquified gluten, and fermented corn product. Other such instances may include: distillers solubles, condensed corn distillers soluble and distillers grains.

As used herein, the term “wet milling” is a process where corn is steeped in water for a period prior to corn being ground by shearing, impacting, or crushing. In some aspects, the corn is steeped for a period of about 32 to about 38 hours.

As used herein, the term “dry milling” refers to a process where the corn is not steeped prior to grinding. After dry milling, the resulting product can be contacted with water for further processing.

As used herein, the term “mineral proteinate” refers to a chelated mineral complex formed by reacting a mineral salt with a protein, peptide, or free amino acids. In the instant invention, the term includes complexes comprising one or more of zinc, manganese, cobalt, copper, and chromium. The term is sometimes abbreviated as “MinPro” herein.

As used herein, the term “corn protein concentrate” is a dried protein fraction of the corn obtained from the wet milling process. In some aspects, the corn protein concentrate comprises about 55 wt % to about 80 wt % protein on a dry weight basis. Some corn protein concentrates can be made as described in published U.S. Patent Application No. 20190133158, incorporated herein by reference in its entirety. For example, the milled corn product is corn protein concentrate that comprises: (i) about 55 wt % to about 80 wt % or preferably about 60 wt % to about 75 wt % corn protein on a dry weight basis; (ii) a “L” color value between about 60 and about 80 or preferably between about 65 and about 75; (iii) a phosphorous content between about 0.2 wt % and about 0.5 wt % or preferably about 0.25 wt % and about 0.4 wt % and a sulfur content between about 0.8 wt % and about 1.2 wt % or preferably about 0.9 wt % and about 1.1 wt %, on dry weight basis; and (iv) a carbohydrate content between about 8 wt % and about 21 wt % or preferably about 10 wt % and about 18 wt % on dry weight basis.

In another example, corn protein concentrate may include: (i) about 20 wt % to about 80 wt % or preferably about 25 wt % to about 75 wt % corn protein on a dry weight basis.

As used herein, the term “corn protein isolate” refers to a corn milling product comprising at least about 85 wt % corn protein on a dry weight basis. In some aspects, the corn protein isolate comprises at least about 65 wt % protein on a dry weight basis. In certain aspects, corn protein isolate comprises about 0.1 wt % to about 3.0 wt %, preferably about 0.5 wt % to about 2.5 wt %, starch on a dry weight basis. In some aspects, corn protein isolate can be made as described in U.S. Patent Application No. 20180118780, incorporated herein by reference in its entirety.

As used herein, the term “steep water” refers to a protein rich aqueous stream from a fermentation and wet-milling process. In some aspects, the protein in the protein rich stream may include amino acids, peptides and polypeptides composed primarily of L-amino acids. In some aspects, the steep water may contain about 5 to about 50 wt % solids. Typically, in the wet milling process, corn kernels can be sequentially steeped, and then milled and separated into their major constituent fractions. The “solubles” fraction, or light steep-water, is a product of steeping the corn, while the germ, fiber, starch, and protein fractions are products of the milling step.

As used herein, the term “heavy steep water”, also known as corn steep liquor, typically obtained by evaporating light steep water to about 42 wt % to about 50 wt % solids. Heavy steep water comprises protein, ash, carbohydrates, lactic acid, etc. and typically has a density of about 1.2 to about 1.4. In some aspects, heavy steep water comprises (i) a biomass sourced from an ethanol yeast fermentation, lactobacillus fermentation, or a combination of both; (ii) about 28 wt % to about 42 wt % or preferably about 30 wt % to about 40 wt % corn protein on a dry weight basis; (iii) a phosphorous content between about 1.6 wt % and about 2.8 wt % or preferably between about 1.8 wt % and about 2.5 wt % on as-is basis, of which >75% are in free, bioavailable form; (iv) a sulfur content between about 0.3 wt % and about 2.0 wt % or preferably between about 0.5 wt % and about 1.75 wt % (at maximum zinc inclusion) on as-is basis, of which >85% are in a sulfate form; (iv) a soluble carbohydrate content between about 12 wt % and about 24 wt % or preferably between about 15 wt % and 20 wt % on dry weight basis; and (iv) an organic acid content between about 16 wt % and about 32 wt % or preferably between about 20 wt % and about 30 wt % on dry weight basis.

As used herein, the term “light steep water” is the unevaporated precursor to heavy steep water. Light steep water has a solids level of about 7 wt % to about 14 wt % and a density of about 1.05 to about 1.08.

As used herein, the term “gluten slurry” is a wet-milling stream where at least a portion of starch has been removed from a solution comprising gluten and starch.

As used herein, the term “liquified gluten” refers to a gluten containing wet-milling stream that has been enzyme treated to hydrolyze a portion of the starch contained within the stream.

As used herein, the term “fermented corn product” refers to a steep water stream that has undergone a fermentation process and/or steep water mixed with an ethanol fermentation biomass stream (or other organic acid fermentation stream).

As used herein, the term “carbohydrate” can include a combination of insoluble starch and soluble oligosaccharides. In any aspect, the carbohydrate may not include fiber. In any aspect, the carbohydrate includes high molecular weight starch hydrolysates.

As used herein, the term “lactobacillus fermentation” means a fermentation product of a milled corn stream where steep water sugars are fermented with lactobacillus bacteria.

A “carbohydrase” is an enzyme that promotes hydrolysis of carbohydrates and starch.

A “protease” is an enzyme that hydrolyzes peptide bonds of proteins.

A “phytase” is an enzyme that catalyzes the hydrolysis phytic acid. Phytic acid can reduce the absorption of metal supplements.

A “L” color value is the lightness value of the CIELAB color space.

The term “bioavailability” means the amount of trace metal that is available to be absorbed and used by the body of the animal that received the nutritional composition. Bioavailability can be determined by the slope-ratio method using multiple regression analysis. Weight gain, tibia trace metal concentration and total tibia trace metal were regressed on supplemental trace metal intake from the trace metal sources and the bioavailability of the trace metal in the trace metal-protein sources was calculated relative to the trace metal source (Zn in ZnSO₄·7H₂O for example). For example, methodologies using broiler poultry can be used for comparative differences by measuring any of the aforementioned properties.

The term “liquefaction” refers to a process where the viscosity of a milled corn component is decreased. Typically, the decrease in viscosity is accomplished using one or more enzymes that can break starch molecules to smaller units.

As used herein, “animal” refers to all creatures that are traditionally defined as animals. These include, but are not limited to, humans, livestock and poultry.

Empyreal® is a proprietary corn protein concentrate marketed by Cargill. One example is Empyreal® 75 (E75).

Sweet Bran® is a corn gluten feed that is high in digestible fiber and marketed by Cargill.

Below are some acronyms used herein. In the case of the analytical methods, the methods are known by those skilled in the art.
Zn-HSW: Heavy steep water with Zn-chelate
PXRD: Powder X-ray diffraction
ICP-OES: Inductively coupled plasma-optical emissions spectrometry
SEM: Scanning electron microscopy
EDS: Energy disperse spectroscopy
TG: Thermogravimetric
DSC: Differential scanning calorimetry.

### Nutritional Composition

The present disclosure provides nutritional compositions that include: (i) one or more of trace metals selected from zinc, manganese, cobalt, copper, and chromium; and (ii) a milled corn product; wherein up to 75 wt % of the trace metal is chelated or complexed within the milled corn product on a dry weight basis, and the amount of trace metal is about 0.025 wt % to about 12 wt %, preferably about 0.1 wt % to about 5 wt %, of the nutritional composition product on a dry weight basis; the amount of protein is about 18 wt % to about 83 wt %, preferably about 20 wt % to about 80 wt %, of the nutritional composition on a dry weight basis. The disclosure also provides food products that include the nutritional compositions as well as methods of using and making the nutritional compositions and food products.

For example, in any aspect, the up to 75 wt % of the trace metal chelated or complexed within the milled corn product on a dry weight basis may include, but is not limited to, from about 15 wt % to about 75 wt %, about 20 wt % to about 70 wt %, about 20 wt % to about 65 wt %, or any range including and/or in between any two of the preceding values.

In some aspects, the milled corn product is wet milled. In other aspects the milled corn is dry milled.

Some milled corn product may include at least one of corn protein concentrate, corn protein isolate, steep water, gluten slurry, liquified gluten, and a fermented corn product. Certain milled corn product may include corn protein concentrate that may include:
(i) about 55 wt % to about 80 wt % corn protein on a dry weight basis;
(ii) a “L” color value of about 60 to about 80;
(iii) a phosphorous content of about 0.2 wt % to about 0.5 wt % and a sulfur content of about 0.8 wt % to about 1.2 wt %, on dry weight basis; and
(iv) a carbohydrate content of about 8 wt % to 21 wt % on dry weight basis.

In some aspects, the corn protein concentrate may include one or more of free amino acids, peptides, oligopeptides, proteinaceous species with specific binding sites towards the trace metals, or free or bonded glycine amino acid.

Some milled corn products may include heavy steep water that may include:
(i) a biomass sourced from an ethanol yeast fermentation, lactobacillus fermentation, or a combination of both;
(ii) about 28 wt % to about 42 wt % corn protein on a dry weight basis;
(iii) a phosphorous content of about 1.6 wt % to about 2.8 wt % and a sulfur content of about 0.3 wt % to about 0.8 wt % on dry weight basis;
(iv) a soluble carbohydrate content of about 12 wt % to about 24 wt % on dry weight basis; and
(v) an organic acid content-between about 16 wt % and about 32 wt % on dry weight basis. Some heavy steep water may include one or more of free amino acids, peptides, oligopeptides, proteinaceous species with specific binding sites towards trace metals and free or bonded glycine amino acid.

Typically, the amount of trace metal may be about 0.05 wt % to about 10 wt % or preferably about 0.1 wt % to about 8 wt % of the nutritional composition on a dry weight basis. In any aspect, the amount of trace metal in the nutritional composition is about 0.025 wt % to about 12 wt % or preferably about 0.05 wt % to 9 wt % or most preferably about 0.075 wt % to about 6 wt % on a dry weight basis. For example, suitable amounts of the trace metal may include about 0.025 wt %, about 0.05 wt %, about 0.075 wt %, about 0.1 wt %, about 0.25 wt %, about 0.5 wt %, about 0.75 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, or any range including and/or in between any two of the preceding values.

In any aspect, up to 75 mol % or preferably up to 90 mol % of the trace metal is chelated or complexed within the milled corn product. For example, about 10 mol % to about 90 mol %, about 20 mol % to about 80 mol %, about 35 mol % to about 75 mol %, or any range including and/or in between any two of the preceding values, of the trace metal is chelated or complexed within the milled corn product. In some preferred aspects, the trace metal is uniformly distributed within the protein.

As described herein, chelation and/or complexation of the trace metal within the corn mill product (i.e., protein) may be determined via one or more detection methods. For example, methods for determining chelation and/or complexation of the trace metal within the corn mill product may include, but are not limited to, X-ray diffraction (e.g., PXRD), optical emissions spectroscopy (e.g., ICP-OES), mass spectrometry (e.g., electrospray ionization mass spectrometry), differential scanning calorimetry (DSC), thermal gravimetric (TG) analysis, or combinations of two or more thereof. The methods for determining chelation and/or complexation of the trace metal by plant derived proteins are known by those of ordinary skill in the art.

Typically, the bioavailability of trace metal is at least about 105% when compared to unchelated trace metal. In certain aspects, the bioavailability of trace metal is about 105% to about 130% when compared to unchelated trace metal.

In any aspect, the nutritional composition may additionally include corn germ meal as a trace metal-protein carrier.

In any aspect, the amount of protein may be about 20 wt % to about 80 wt % or preferably 25 wt % to about 75 wt % or most preferably 30 wt % to about 70 wt % on a dry weight basis.

### Methods for Preparing the Nutritional Composition

In other aspect, the present disclosure provides methods of producing a metal chelated milled corn product that includes (i) contacting at least one milled corn product with a salt (or hydrate thereof) that includes a trace metal selected from zinc, manganese, cobalt, copper, and chromium in the presence of water to produce the metal chelated milled corn product; and (ii) removing at least a portion of the water from the metal chelated milled corn product; wherein the amount of water is about 26 wt % to about 88 wt % prior to removing at least a portion of water from the metal chelated milled corn product.

In any aspect, the corn product may be processed by wet milling or dry milling processes.

In some wet milling processes, a batch of corn is fed into a steep tank. Liquid is provided to the steep tank. Preferably, the liquid is edible and/or food-compatible since it will be contacting corn, which may eventually be used for inclusion in animal feed and/or human food. Examples of suitable liquids may include, but are not limited to, water, brine or salt solutions (e.g., 0.001 M to 1.0 M sodium chloride solutions), sugar solutions, glycerol, alcohols (e.g., ethanol) or alcohol/water solutions and edible oils (e.g., soybean oil, corn oil, peanut oil, sunflower seed oil). Antioxidant(s), antifungal(s) and/or antibacterial material(s) can optionally be present in the liquid. The liquid added to the tank may be any suitable liquid or mix of liquids, such as recycled liquid, recycled from, for example, a previous steeping or separation process or from another step of the corn processing process. Examples of suitable liquids for processes of this disclosure include mill water, mill water to steep or steep mill water, and steep water(s) (e.g., light steep water, thin stillage, heavy steep water, or intermediates).

In certain corn wet milling processes, the cleanest water, typically potable or city water, is used to first wash starch and is then used in the milling of corn, accumulating corn solubles, typically at a level of less than about 4 wt % dry solids. This water in the wet milling process is commonly known as mill water, process water, or mill process water. Mill water, after being used in wet milling processes, can be treated with sulfite and introduced to the steep battery as mill water to steep (or, steep mill water). Typically, mill water to steep has less than about 4 wt % dry solids. During steeping, water flows counter current in the steep battery, so that newest water (mill water to steep) encounters the longest steeped corn, with that water moving forward in the process contacting progressively newer corn the battery. As the water progresses through the steep battery, it decreases in SO₂ concentration, increases in solubles, and increases in lactic acid. Dry solids range from less than about 4 wt % to about 7 wt %. Light steep water (“LSW”) is the oldest water in the steep battery and/or the water draw off of the steep battery and contains protein, ash, carbohydrates, lactic acid, etc. at a level of about 7 wt % to about 14 wt % solids. LSW typically has a density of about 1.05 to about 1.08. In some cases, LSW can be utilized in ethanol fermentation process, which can produce along with other fermentation streams a byproduct of yeast biomass known as thin stillage at a dry solids level of about 5 wt % to about 20 wt %. Heavy steep water (“HSW”), also known as corn steep liquor, is light steep water that has been concentrated by evaporation to approximately 45 wt % to about 50 wt % dry solids. HSW typically has a density of about 1.2 to about 1.4. Intermediate evaporated steep water(s) are partially evaporated light steep water, with a dry solids and density between light steep water and heavy steep water (for example, with a density of about 1.15).

The products of the wet milling of the corn, such as protein concentrate, light steep water (LSW), and heavy steep water streams, can be isolated and used in the production of the metal-chelated products described herein. The products can be contacted with one or more carbohydrases and/or proteases to promote hydrolysis of carbohydrates and/or proteins in the product. Representative carbohydrases include, but are not limited to alpha amylase, dextrinase, pullulanase, glucoamylase, hemicellulase, cellulase, or mixtures thereof. Representative proteases include endo-proteases (with hydrolytic activity), transglutaminases (for protein modification), and protein-glutaminases/deamidation (as glutamine is the most abundant amino acid in corn protein). Endo-proteases typically solubilize/liberate peptides by endo action of insoluble material targeting abundant amino acids in corn protein, such as Pro, Gln, Ala and Leu to enhance the chelation process. Similarly, protein glutaminases provides targeted protein hydrolysis and allows a catalyzed deamidation modification to generate a wider PI ranges for the protein chelated with the metals. Transglutaminase can attach polar proteinaceous/peptide species, such as di-glycine, to enhance the chelation process.

Trace metals used in the process include, but are not limited to zinc, manganese, cobalt, copper and chromium. The amount of trace metal in the nutritional composition can be at least about 0.025 wt % or at least about 0.05 wt % on a dry weight basis. In any aspect, the amount of trace metal in the nutritional composition is about 0.025 wt % to about 12 wt % or preferably about 0.05 wt % to 9 wt % or most preferably about 0.075 wt % to about 6 wt % on a dry weight basis. For example, suitable amounts of the trace metal may include about 0.025 wt %, about 0.05 wt %, about 0.075 wt %, about 0.1 wt %, about 0.25 wt %, about 0.5 wt %, about 0.75 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, or any range including and/or in between any two of the preceding values. In certain aspects, the trace metal is uniformly distributed within the nutritional composition.

Typically, the source of trace metal used in the methods of producing the nutritional composition or metal chelated milled corn product are water-soluble salts of zinc, manganese, cobalt, copper, and chromium, i.e., the trace metal salt has solubility in water sufficient to make the trace metal ions available for chelation and/or complexation with the at least one milled corn product in the inclusion amounts described herein. For example, the trace metal salt may be selected from sulfate and halide salts of zinc, manganese, cobalt, copper, and chromium. Preferably the trace metal salts may include, but are not limited to, trace metal sulfates (e.g., ZnSO₄, MnSO₄, CoSO₄, CuSO₄, Cr₂(SO₄)₃), or combinations of any two or more thereof), trace metal halides (e.g., ZnX₂, MnX₂, CoX₂, CuX₂, CrX₃, or combinations of any two or more thereof; where X═Cl, Br, or I). Preferably the trace metal compounds (i.e., trace metal salts) used in production of the nutritional composition or metal chelated milled corn product include one or more of ZnSO₄·7H₂O, MnSO₄·7H₂O, CuSO₄·5H₂O, CoSO₄·7H₂O, and CoCO₃·6H₂O.

In some nutritional composition or metal chelated milled corn products, at least about 75 wt %, about 80 wt %, about 85 wt %, about 90 wt %, about 95 wt % or about 99 wt % of the trace metal is chelated or complexed within the milled corn product.

The corn protein concentrate described herein can be made by the process described in PCT Application No. PCT/US2005/003282, which is incorporated herein by reference in its entirety. Briefly, the corn protein concentrate can be prepared by a process that includes contacting one or more corn protein-containing materials with one or more wet-mill streams and one or more carbohydrases.

In some aspects, the corn protein concentrate described herein generally has at least about 50% or about 70% protein (on a dry weight basis) (e.g., 50%, 55%, 60%, 65%, 70%, 75%, 80%, 85%, 90% on a dry weight basis). In other aspects, corn protein concentrate that comprises: (i) about 20 wt % to about 80 wt % (e.g., 20%, 25%, 30%, 35%, 40%, 45%, 50%, 60%, 65%, 70%, 75%, or 80%) or about 25 wt % to about 75 wt % corn protein on a dry weight basis. In any aspect, the corn protein concentrate can include corn gluten meal (CGM). Additionally or alternatively, the corn protein concentrate as described herein in any aspect may include corn gluten feed (CGF) having at least about 12.5 wt % protein.

Certain aspects can utilize a dry milling process. In these processes, the corn is not steeped prior to grinding. After dry milling, the resulting product can be cooked, liquified and/or fermented. Analogous products to those made from wet milling can be made and utilized in the products and methods discussed herein.

### Animal Feed

In yet another aspect, the present disclosure concerns an animal feed comprising 0.0001 wt % to 0.8500 wt % of a nutritional composition as described herein in any aspect. For example, an animal feed comprising 0.0001 wt % to 0.8500 wt % of a nutritional composition, wherein the nutritional composition comprises: (i) one or more of trace metals selected from zinc, manganese, cobalt, copper, and chromium; and (ii) a milled corn product comprising protein; wherein up to about 75 wt % of the trace metal is chelated or complexed within the milled corn product on a dry weight basis; wherein the amount of trace metal is about 0.025 wt % to about 12 wt % of the nutritional composition product on a dry weight basis; and the amount of protein is about 18 wt % to about 83 wt % of the nutritional composition on a dry weight basis.

For example, the animal feed may include 0.0001 wt % to 0.8500 wt %, preferably 0.0010 wt % to 0.7500 wt %, more preferably 0.0025 wt % to 0.5000 wt %, even more preferably 0.0030 wt % to 0.1000 wt %, or most preferably 0.0030 wt % to 0.0300 wt %.

Some animal feeds comprise the nutritional composition having an amount of trace metal of about 0.05 wt % to about 10 wt % or preferably about 0.075 wt % to about 7 wt % of the nutritional composition on a dry weight basis. In any aspect, the animal feed comprises 0.00001 wt % to 0.0025 wt % of the trace metal based on total weight of the animal feed, preferably 0.00005 wt % to 0.0015 wt %, more preferably 0.0001 wt % to 0.0010 wt %, most preferably 0.0002 wt % to 0.0009 wt %.

In certain animal feeds, the animal feed may include a nutritional composition having up to about 90 mol % or up to about 80 mol % of the trace metal is chelated or complexed. In certain animal feeds, the trace metal present in the nutritional composition is uniformly distributed within the protein. In some aspects, the bioavailability of trace metal is at least about 105%, preferably about 105% to about 130%, most preferably about 110% to about 125% when compared to unchelated trace metal.

Some animal feeds additionally and/or alternatively comprise corn germ meal as a trace metal-protein carrier.

Other aspects provide methods of feeding animals and methods of making animal feeds.

Methods of feeding animals include feeding the animal a feed diet comprising 0.0001 wt % to 0.8500 wt % of one or more nutritional compositions, based on total weight of the feed diet, as described herein in any aspect. The nutritional composition can be included in a concentrate, a premix, a top dress, total mixed ration, or combinations of two or more thereof.

The animal's diet can include a daily feed ration including the one or more nutritional compositions. The daily feed ration can be in any suitable form, such as in the form of a pellet, a mash, an extruded food, an expanded food, or a combination thereof. The daily feed ration can be a complete feed including a base animal feed that includes the one or more nutritional compositions, or the daily feed ration can be a complete feed including a base animal feed and a premix, concentrate, or top dress that includes the one or more nutritional compositions.

The animal can be any suitable animal at any suitable age or stage in agricultural (i.e., livestock and/or aquaculture) production such that the animal benefits from the diet including the nutritional compositions as described herein in any aspect. In some aspects, the animal is not human. For example, the animal can be a ruminant, pig, poultry, horse, aquaculture, or wild game. Additionally and/or alternatively, the animal may as used in the present disclosure includes monogastric animals. The term “monogastric” refers to any organism having a simple single-chambered stomach. Such monogastric animals include, but are not limited to, porcine (i.e., pigs or boars), equine, avian animals (e.g., poultry), and/or seafood (or aquaculture) animals. In certain aspects, the animal feed is a poultry feed. The term “poultry feed” refers to a feed ration produced for consumption by poultry.

The term “poultry” as used herein refers to domestic fowls, including chickens, turkeys, geese, ducks, ostriches, quails, and pheasants raised for the production of meat or eggs. Chickens include “layers” reared for laying eggs, and “broilers” for meat production. Chickens also include “breeders,” i.e., birds that have reached the age of sexual maturity and may lay eggs. Typically, the poultry may be selected from chicken, a turkey, a duck, and a goose, and preferably, the poultry animal is a chicken. While the present technology is suitable for use in any chicken breed, typically, the present technology may be suitable for chicken breeds, including but not limited to, Ross, Cobb, Isa Brown, Hubbard, Shaver, Abor Acres, Indian River, Peterson, and Dekalb white chickens, preferably the chicken may be a Ross and/or Cobb chicken.

The present disclosure provides a concentrate, premix, or top dress for animals that includes the one or more nutritional compositions as described herein in any aspect that can be used to form a product or perform a method of as described according to the present invention. A concentrate is a composition that can include high-protein feed components and can also include vitamins, minerals, appropriate medications, and combinations thereof. A concentrate is typically less than about 50 wt %, preferably between about 5 wt % to about 40 wt % of the animal feed diet but can be higher or lower. A concentrate can include additives. Concentrates can be used to make complete feeds by adding available grains or other energy sources. Premixes are compositions that can include vitamins, minerals, appropriate medications, carriers, and combinations thereof, and are typically less than about 2 wt %, preferably less than about 1 wt %, most preferably between about 0.25 wt % and about 1 wt % of the animal feed diet, but can be higher. The carrier can increase bulk to improve distribution in compounding to prepare a more complete feed material. Examples of carriers can include soy mill run, rice bran, and similar edible plant by-products. Such premixes can be used to formulate concentrates and complete feeds. A premix can be a feed additive. A top dress is a supplement added at specific time intervals to the animal ration to provide a specific supplement or supplements over a period of time that makes it inconvenient or difficult to include in complete feed. Concentrates, premixes, and top dresses can be offered to the animal alone or compounded with other materials. The concentrate or premix can be for use with animals as described herein, including but not limited to, ruminants, pigs, poultry, equine animals, aquaculture, wild game, or a combination thereof. Additionally and/or alternatively, the concentrate or premix can be for use with companion animals (i.e., pets, including dogs, cats, and the like). Additionally and/or alternatively, the animal feed may be a feed “supplement.” As used herein in any aspect, the terms “feed supplement” or “animal feed supplement” refers to a concentrated additive premix that includes the active ingredients, which premix or supplement may be added to an animal's feed or ration to form a supplemented feed in accordance with the present disclosure. As used herein in any aspect, the term “additive” or “feed additive” refers to an ingredient such as a protein source, salt, mineral, additive, or buffer that is added to an animal feed.

Certain aspects of the invention concern a complete feed for animals comprising a concentrate, premix, or top dress containing one or more nutritional compositions as described herein in any aspect.

Other aspects concern methods of making a complete feed, the method comprising combining the concentrate, premix, or top dress as described herein with a base animal feed to form the complete feed or total mixed ration (TMR).

The complete feed includes a base animal feed. The term “base animal feed” as used in any aspect described herein refers to a blend containing vitamins, trace minerals and/or other micro ingredients plus macro minerals such as calcium, phosphorus, sodium, magnesium, and potassium, vitamins, or combinations thereof. A complete feed is a nutritionally adequate feed for animals that is compounded to be fed as the sole ration and is capable of maintaining life and/or promoting production without any additional substance being consumed except water. Complete feeds are compounded mixtures containing all the nutrients of concentrates plus various energy sources such as grains, some fat, and the like. In addition, certain major minerals may be added. An example of additional ingredients in a complete feed can include cottonseed meal, rapeseed and canola meals, meat and bone meal, wheat middlings, soybean meal, corn gluten meal, distiller's grains, blood meal, salt, macro-minerals, minerals, vitamins, and combinations thereof.

Yet other aspects of the present disclosure concern methods of feeding an animal, the method comprising feeding the animal an animal feed comprising a nutritional composition as described herein in any aspect.

Still other aspects concern use of the animal feed, concentrates, premixes, or top dresses as described herein in any aspect. The disclosure also concerns improving the bioavailability of trace nutrients in an animal feed, wherein the animal feed and/or animal feed diet includes the nutritional composition as described herein in any aspects.

In another aspect, the present disclosure provides food products containing the nutritional composition as described herein in any aspect.

Various aspects of the present disclosure are further illustrated with respect to the following examples. It is to be understood that these examples are provided to illustrate specific aspects of the present disclosure and should not be construed as limiting the scope of the present disclosure in or to any particular aspect.

### EXAMPLES

### Examples 1.1-1.5: Empyreal 75-Zn Chelates

### Example 1.1

Objective: The aim of the initial test was to incorporate 1 wt % of Zn in the Empyreal 75 (E75) protein matrix prior to a liquefaction process.

Materials & Methods: Two portions of 200 g of heavy gluten slurry (adjusted to pH 5.2) were treated with alpha-amylase for 5 h at 95° C. to extensively hydrolyze starch and convert it into a soluble carbohydrate stream. Prior to liquefaction, one portion was treated and mixed with ZnSO₄·H₂O at 1 wt % of gluten solids. Post liquefaction, both cakes were triple washed with city water to remove any residual soluble carbohydrates. The E75 wet cakes were then dried in a fluidized bed dryer (FBD). For initial screening of the preparation method, dried E75 solids were evaluated by PXRD, along with the freeze-dried liquid portions. PXRD analysis was used to determine the spatial structure of chelates. (Li, Chen et al., Preparation and structural characterization of peanut peptide-zinc chelate, CyTA—Journal of Food, 2020, vol. 18, No. 1, 409-416). During PXRD analysis, certain wavelengths are irradiated onto the crystalline substance, which are scattered by atoms or ions encountered in a regular arrangement in the crystal. A unique diffraction phenomenon is generated.

The dried E75 solids and the liquid portions were further screened on ICP for Zinc contents.

A portion of the liquid samples were lyophilized prior to being tested on the PXRD.

For ICP analysis, liquid or solid samples were acceptable. Both washes and retains were tested for Zn content to perform mass balance. The samples were first acid digested using a Milestone UltraWave. Approximately 0.5 g of sample was digested in 3 mL of nitric acid at 240° C. for one (1) hour. The samples were diluted appropriately with ultra-pure water to fit within the set calibration curve. Elemental analysis was performed by Inductively Coupled Plasma-Emission Spectroscopy (ICP-OES) with target element of Zinc (Zn). This analysis was performed in reference to EPA 200.7 (“Determination of Metals and Trace Elements in Water and Wastes by Inductively Coupled Plasma-Atomic Emission Spectrometry”).

The ICP results showed that almost 71.8% of Zn is washed away with the liquids while 28.2% are retained in the final E75 solids (after the triple washes) with a good mass balance that is closed out to nearly 100%. Almost 4500 ppm of Zn is present in E75 solid where a minimum of 300 ppm is needed for value-added feed product.

No crystallinity was detected in the Zn-treated solids. However, a high level of Zn retention within the protein matrix was demonstrated.

### Example 1.2

Objective: The aim of this second test was to incorporate higher inclusions (12%) of Zn metal in the E75 protein matrix before and after the liquefaction process.

Materials & Methods: Building on Example 1.1, higher inclusion of Zinc in E75 were produced using the following steps:
(1.2A) Four portions of 200 g of heavy gluten slurry (adjusted to pH 5.8) were treated with alpha-amylase for 5 h at 95° C. to completely hydrolyze starch and convert it into a soluble carbohydrate stream. Two portions were treated with the addition of ZnSO₄·7H₂O prior to the liquefaction while the other two remained as control. The wet cake formed from one of the two controls was blended with ZnSO₄ salt.
(1.2B) Portions of E75 (200 g of liquefied E75 slurry or 80 g of E75 wet cakes) were treated with ZnSO₄·7H₂O salt for 1 h at 80° C. after the liquefaction while one portion wet cake remained as TO control. In wet cake condition (T1), the Zn salt was completely dissolved in water and then mixed with the slurry. In the T2 condition, the salt was added to the E75 slurry. In T3 conditions, the salt was added to E75 slurry either dissolved or as-is salt form.

For samples evaluated under (1.2A) and (1.2B), PXRD was used to screen for complexation and/or chelation of Zn. PXRD results showed a strong crystallinity profile at higher Zn inclusion of 12% and triple washes. The 2-theta peaks and their corresponding d-spacings were present at different diffraction angles than Availa®-Zn-120, a commercially available zinc amino acid complex produced by ZinPro®, but at some matching angles of the ZnSO₄ salt with varying abundance, indicating a different type of crystalline form was developed within the E75 protein matrix and zinc ions. In particular, the 2-theta peaks and their corresponding d-spacings were present at a specific diffraction angle of 28° that is different from the abundant number of angles observed for the ZnSO₄ salt, indicating a different type of crystalline form was developed within the E75 protein matrix and Zinc ion. For 1.2A, the intensity of the peaks was very different as well, which indicated a different arrangement of Zn atoms within the crystals within the protein matrix of E75. For 1.2B, the intensity of the peaks varied based on the treatment, which indicated a different arrangement of Zn atoms within the crystals embedded in the protein matrix of E75. The dissolution of ZnSO₄ in water prior to its addition to the E75 slurry resulted in a smaller crystalline pattern.

Without being bound by any particular theory, it is believed that under no-wash conditions for samples evaluated under 1.2A and 1.2B, the lack of crystallinity is attributed to the retained soluble carbohydrates that may cause a higher amorphous characteristic of the protein matrix.

For 1.2A and 1.2B, the freeze-dried liquids showed a different form of crystallinity on the PXRD as compared to ZnSO₄ salts and Zn-E75 treated solids. The dried liquids exhibited a similar crystalline profile across the treatments with exact 2-theta values and corresponding d-spacing (specifically at 26.2° and) 32°, indicating the presence of appreciable chelation with the soluble protein matrix. Comparatively, peaks were also present at totally different diffraction angles than the Availa®-Zn-120 solids.

Similar to the 1% Zn inclusion experiment, the ICP results showed that almost 76.5% of Zn is washed away with the liquids while 23.2% are retained in the final E75 solids (after the triple washes) with a good mass balance that is closed out to nearly 100%. Almost 31,000 ppm of Zn is present in E75 solid where a minimum of 300 ppm is needed for value-added feed product.

In the 1 h treatment under 1.2B (vs. 5 h treatment), the freeze-dried liquids (controls, T2, T3-0, T3-1, and T3-2 washes) showed a pattern-shift in the PXRD crystalline profile as compared to ZnSO₄ salts and Zn-E75 treated solids. The dried liquids exhibited a similar crystalline profile across the treatments with exact 2-theta value of 28° and corresponding d-spacing, indicating the presence of appreciable chelation with the soluble protein matrix. More peaks were detected in the first liquid separation as compared to the later washes 1 and 2. The dissolution of ZnSO₄ in water prior to its addition to the E75 slurry resulted in the destruction of crystalline pattern. Peaks were also present at totally different diffraction angles than the Availa®-Zn-120 solids & zinc sulfate salts. These liquids, typically recycled in the mill, have the potential to be isolated and concentrated on their own to make Zn-protein-CHO syrup with higher value-added properties for feed applications.

### Example 1.3

Objective: This example is a comparative study to understand the interaction of Availa®-Zn-120 with E75 and to assess whether the incorporation of an amino acid would enhance the chelation process between the Zn metal and E75 protein matrix.

Materials & Methods: To further validate the chelation/complexing in the E75 protein matrix, Availa®-Zn-120 (Zinpro Corporation) was utilized instead of ZnSO₄. Four types of samples were prepared:
1. Dry blend Availa®-Zn-120 with E75 dry product in coffee grinder at these inclusion rates (0 wt %, 0.1 wt %, 0.5 wt %, 2.5 wt %, and 10 wt %) and test them on PXRD.
2. Blends of Availa®-Zn-120 with wet E75 cake (collected from Source 1 plant drum filters) in coffee grinder at these inclusion rates (0 wt %, 0.1 wt %, 0.5 wt %, 2.5 wt %, and 10 wt %); the blends were dried in FBD, and then tested on PXRD.
3. Mixtures of Availa®-Zn-120 with Liquefied E75 slurry at similar inclusion rates (as taught above) for 30 min and filtered liquids. The wet cakes were: (a) dried on FBD and tested on PXRD, or
(b) triple washed & dried on FBD, and then tested on PXRD.

Results from the dry-blended samples showed crystalline peaks with the highest Availa® inclusion of 10% with similar lattice d-spacing (and 2-theta) as compared to the Availa®-Zn-120 PXRD spectrum at the same concentration. Lower Availa® inclusion has complete absence of crystallinity.

Results from the wet-blended and dried samples showed an intense crystalline peak with the highest Availa® inclusion of 10% with similar lattice d-spacing (and 2−theta=29.5°) as compared to the Availa®-Zn-120 PXRD spectrum. This was also associated with a complete absence of crystallinity defined by the other 4 peaks (2−theta=19.5°, 23°, 36°, &) 39.5°, specific for Availa®-Zn-120. This data clearly shows the different behavior between dry and wet blending and its strong impact on Zn-protein interaction. The increased intensity of the 29° peak is a proof of rearrangement of Zn atoms with the Zinpro product that have been strongly embedded in the E75 protein matrix to form a new crystalline structure (attributed to a new chelate formation).

Similar to wet blending, results from the slurry-treated and washed samples showed an intense crystalline peak with the Availa® inclusion of >0.5% with similar lattice d-spacing (and 2−theta=29.5°) as compared to the Availa®-Zn-120 PXRD spectrum. This was also associated with a complete absence of crystallinity defined by the other 4 peaks (2−theta=19.5°, 23°, 36°, &) 39.5°, specific for Availa®-Zn-120. The single-wash solids showed a crystalline profile closer to Availa®-Zn-120 at 2.5 and 10%, however, with much less intense peaks. The increase in intensity of the 29° peak in the triple washed samples (from 135 to 4800, 160 to 750, and 340 to 1750 au in 0.5, 2.5, and 10% inclusion, respectively) provided proof of rearrangement of Zn atoms from the Zinpro® product that have been strongly embedded in the E75 protein matrix upon triple washing with water to remove any soluble carbohydrate and allow the reforming a new crystalline structure (attributed to a new chelate).

### Example 1.4

Objective: The presence of high suspended solids in the analyzed material may hinder the detection of the Zn-protein chelates, therefore in Example 1.5, extracts of Corn Gluten Meal (CGM), E75, and steep and their fractionated peptides (on various molecular weight cut-off (MWCO) membranes) were tested as they treated with various levels of Zn & Cu incorporations.

Materials & Methods: Peptides separated from the extracts of Empyreal 75 and Gluten products and the steep liquid media (at 1K Da, 3KDa, and 10KDa) were treated with specific amounts of either Zinc or Copper ions and tested on electrospray ionization mass spectrometers (ESI-MS).

As shown in Table 1 below, ESI-MS m/z ions data showed that variety of trace metal-peptide chelates were detected (Cu & Zn), validating the presence of these molecular ions of interest with specific molecular weight ranges. These molecular weights correspond to the weight of di-, tri-, tetra-, or oligo-peptides attached to either metal (Zn or Cu) in their variables form of abundant isotopes (⁶⁴Zn, ⁶⁶Zn, ⁶⁸Zn or ⁶³Cu, ⁶⁵Cu). The m/z values below represent only the abundant isotopic form of the chelates.

TABLE 1
ESI-MS Peaks

| Zinc | Gluten | E75 | Steep | Copper | Gluten | E75 | Steep |
|---|---|---|---|---|---|---|---|
| 1 kD | 247 | 247 | 1999 | 1 kD | | 336 | 2413 |
| | 337 | 337 | 2139 | | | 361 | |
| | | 429 | 2178 | | | 1305 | |
| | | 2903.6 | 2639 | | | 2089 | |
| | | | | | | 2150 | |
| | | | | | | 2386 | |
| 3 kD | | 339 | | 3 kD | 343 | 190 | |
| | | | | | | 192 | |
| | | | | | | 1029.6 | |
| | | | | | | 1047.7 | |
| | | | | | | 118.6 | |
| | | | | | | 1329.7 | |
| | | | | | | 1992.5 | |
| 10 kD | 116 | 247 | 327 | 10 kD | Multiple | 213 | |
| | 247 | 337 | 344 | | hydrates | 215 | |
| | 2192 | 568.9 | 433 | | >300 amu | 244 | |
| | 2309 | 647.8 | | | | 285 | |
| | | | | | | 319 | |
| | | | | | | 339 | |
| | | | | | | 2261.6 | |

### Example 1.5

Objective: As the 1 wt % inclusion of Zn was not detected on PXRD, the aim of this test is to incorporate higher inclusions (12 wt %) of Zn metal in the E75 protein matrix before and after the liquefaction process

### Materials & Methods

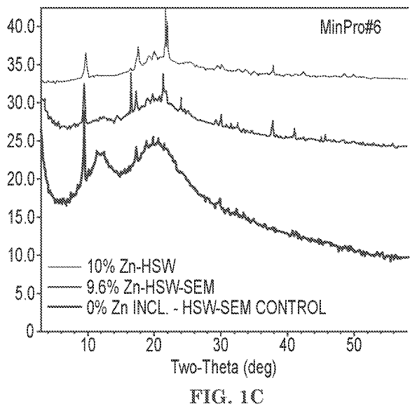

1.5A: As described in previous examples, higher inclusion of Zinc in E75 was produced using the following steps:
   1. Four portions of 200 g of heavy gluten slurry (adjusted to pH 5.8) were treated with alpha-amylase for 5 h at 95° C. to hydrolyze starch and convert it into a soluble carbohydrate stream. Two portions were treated with the addition of ZnSO₄·7H₂O prior to the liquefaction while the other two remained as control.
   2. The 1st and 3rd wet cakes, which were treated with ZnSO₄, were dried separately in the fluidized bed dryer to <10 wt % moisture (E75 cake C and E75 cake T2), while the remaining two cakes were further treated.
   3. One untreated E75 wet cake was then blended with ZnSO₄·7H₂O crystals in Kitchen-Aid blender for two minutes at two different speeds (1 min at speed #1+1 min at a faster speed, #2). The resulting material, designated E75 Cake T1, was dried in FBD.
   4. The other untreated E75 wet cake was washed twice with city water to completely wash away any free Zn in the solid matrix. The E75 Cake T3 was then dried in FBD.
1.5B: Building on the series of zinc chelation in Empyreal liquefaction process, the study was repeated with the 12% inclusion of Zinc in E75 produced using similar steps as outlined below:
   1. Portions of E75 (200 g of liquefied E75 slurry or 80 g of E75 wet cakes) were treated with ZnSO₄·7H₂O salt for 1 h at 80° C. post to the liquefaction while one portion wet cake remained as TO control. In wet cake condition (T1), the Zn salt was completely dissolved in water, while the salt was added to (a) the E75 slurry in T2 condition and (b) the E75 slurry in T3 conditions (either dissolved or as-is salt form) as detailed in FIG. 2.
   2. Post slurry treatments, all T2 & T3 slurries were centrifuged at 4000 rpm for 5 min and the wet solids were collected.
   3. The 1st and 3rd wet cakes were dried separately in the fluidized bed dryer to <10% moisture (E75 cake C and E75 cake T2), while the remaining two cakes were further treated.
   4. One untreated E75 wet cake was blended with ZnSO₄·7H₂O solution in a kitchen-Aid blender for two minutes at two different speeds (1 min at speed #1+1 min at a faster speed, #2) to make the E75 Cake T1 and then dried in FBD.
   5. The other untreated E75 wet cake was washed twice with city water to completely wash away any free Zn in the solid matrix. The E75 Cake T3 was then dried in FBD.

In addition to ICP-OES and PXRD, all solid samples were tested on scanning electron microscopy with energy disperse spectroscopy (SEM-EDS), thermogravimetric (TG) analyzer, and differential scanning calorimetry (DSC). The five analytical techniques are known in the art to support a showing of metal complexation and/or chelation with plant-derived proteins. (Li et al., CyT—Journal of Food, 2020). While PXRD data described in Examples 1.1-1.5 provided initial support for the formation of trace metal-protein chelates, further characterization of zinc-protein complexation via SEM-EDS, TG, and DSC provided additional proof of zinc-protein complexation and/or chelation as described in the present examples. Below is a brief description of each one of the remaining three techniques.

SEM-EDS Analysis (Qualitative and Quantitative): SEM-EDS is used for imaging, elemental analysis (Zinc, Sulfur, & Nitrogen), and chemical characterization of a metal-protein substrate. It is based on a source of X-ray excitation and an emitting sample to enable the characterization of elements' abundance within a small sample volumes (10-30 μm³). The chemical information is visualized in several ways including elemental mapping and line scans to colocalize the zinc and protein-nitrogen atoms in the micro-region and utilize it as a proof of chelation. SEM-EDS allows tiny and even undetectable substances to be magnified several thousand-fold, allowing for observation of morphological changes and quantitative analysis of elemental composition. (Li et al., CyT—Journal of Food, 2020).

TG Analysis (Qualitative): TGA is an analytical technique that measures the thermal stability of a material by monitoring the weight of the sample while heating at a constant rate. The changes in a sample's weight are typically attributed to a specific material response (single or multi-stage decomposition), composition change, and/or a thermal stability. As chelated to a metal, the thermal response of a protein matrix may shift to indicate a faster or slower decomposition, depending on the stability of the complex formed. Observation of these two characteristics indicate the formation of metal protein chelates. (Li et al., CyT—Journal of Food, 2020).

DSC Analysis (Qualitative): By heating the chelated sample and measuring the heat flow (against a reference standard), we can determine the thermodynamic data of a given chelate as compared to the pure protein form (E75 or HSW). DSC curves are generated by charting the heat flow (mW=mJ/sec) against the sample temperature (° C.). When the sample undergoes a physical transformation such as phase transitions (glass transition, crystallization, or melting), more or less heat will flow to it than the reference to maintain both at the same temperature.

For samples prepared under 1.5A and 1.5B, SEM equipped with an energy-dispersive X-ray spectroscopy (EDS or EDX) was utilized to image and analyze the elemental composition of the metal-protein substrates at nm scale in both Zn-E75 (prepared in various ways) and control E75. N, S, and Zn were selected as major elements of interest for the elemental mapping and spectral scanning; as N is a major element in E75 and HSW protein, Zn in the zinc sulfate salt, and S as the common element in both protein (from E75 or HSW) and zinc sulfate salt. For samples under 1.5A, the frequency of detection of zinc decreased with increased washing; unwashed material had the most Zn (T1>T2>T3>C). Zn levels were also evenly distributed within the matrix of E75 solids and colocalized with the N elements of their proteins. Sulfur element was also uniformly distributed in the solid/protein matrix. However, this was not the case with dry blending where a complete segregation between elements of E75 and zinc sulfate salts was detected. Similarly, elemental spectra showed a decrease in Zn peak area as the washing steps increased (in all cases, wet blends, dry blends, and washed cakes). Similar results were observed for samples evaluated under 1.5B.

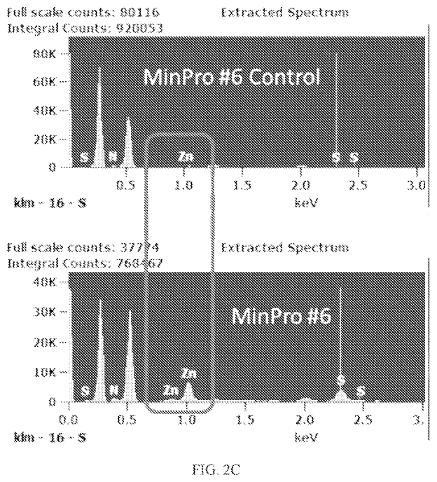

For samples evaluated under 1.5A, TG analysis (FIG. 4) showed a shift in weight loss was detected at increased temperature as more zinc was retained in the Zn-E75 samples (T1>T2>T3>C), which corresponds to a shift in compositional nature of the analyzed materials. A shift to the right (and in some cases divided in two or multiple steps) in the decomposition rate (delta weight/delta temp) is detected at higher temperature, indicating new stabilized structures formed upon the addition of higher amounts of zinc metals. The shift is clearly detected in the wet blend Zn-E75 and carries on to a much higher temperature (in the 500-600° C.), which is indicative of a strong interaction/binding (intermolecular and intramolecular forces) between the Zn ions and protein/solid matrix of E75. The weight loss detected between 0 and 100° C. is mainly attributed to the water removal from the samples at starting point. Similar results were observed for samples evaluated under 1.5B.

Similarly, DSC scans for samples evaluated under 1.5A further supported the formation of zinc-protein complex, which was useful in determining thermodynamic factors and binding behaviors of metals in protein structure (Zn atoms in E75, as prepared with various washing/blending methods). The conformational stability of Zn-E75 protein and zinc binding during the thermal process was detected. It was separated from the ZnSO₄·7H₂O salt by the absence of the endothermic dehydration broad peaks between 37 to 55° C. and 60 to 85° C. Similar results were observed for samples evaluated under 1.5B.

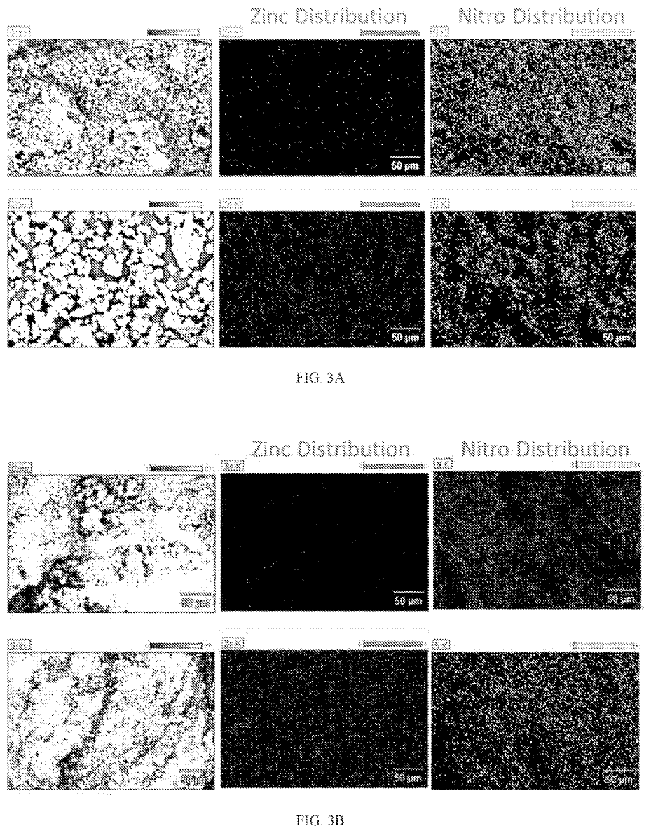

As shown in FIG. 5, the negative heat flows of the DSC curves are representative of transition temperatures of the E75 control or Zn-E75 complex indicating a structural changes in the protein matrix. Shifting to the right in the transition temperature is indicative of stronger binding while to the left is indicative of weaker binding, which was the case of all Zn-E75 complexes formed under various conditions. The obtained DSC curves also showed that the Zn-E75 complex made by wet blending were much stronger and very different than the one made by conventional dry blending. The negative heat flows are representative of the melting transition temperatures Tm of the E75 control or Zn-E75 complex. The Zn-E75 complex made by wet-blending showed a shift to the to the right in the transition temperature indicating of stronger binding while the remaining complexes sowed a shift to the left indicating of weaker binding. Similar results were observed for samples evaluated under 1.5B.

### Examples 2.1-2.2: Zn-HSW Chelates

### Example 2.1

Objective: The aim of this test was to incorporate Zn metal in the heavy steep water (HSW) protein matrix at variable inclusion rates (0, 2, 5, and 10 wt %) prior to utilizing it in feed manufacturing.

Materials & Methods: 200 g of liquid HSW samples were prepared to be mixed with ZnSO₄·7H₂O to make one of the four inclusions levels of Zn in HSW (0, 2, 5, and 10 wt % on dry basis). A total of eight portions of HSW were utilized in every treatment (since we were targeting two different types of HSW). Each portion of HSW was warmed up to 50° C. in water bath after the addition of Optimash phytase (200 μl) to hydrolyze any phytic acid that might chelate with the Zn metal. ZnSO₄·7H₂O was then mixed with deionized water to facilitate the Zn²⁺ ion dissolution in the HSW portion (all amounts are listed in the Table 1). The Zn solution was then dispensed into the warm HSW in each of the eight containers, mixed well, and then incubated at 50° C. for one hour with agitation. The samples were tested as-is on ICP-OES, DSC and TGA. Portions of the 8 samples were freeze dried at MRDC and tested on PXRD and SEM-EDS and on DSC at MRDC. In some cases, HSW samples were spun down at 4000 rpm for 5 min and the air-dried solids were tested on PXRD.

ICP-OES Analysis (Quantitative): As discussed above, ICP-OES is a technique used for the determination of trace elements, such as alkali metals, transition metals (i.e., Zn, Cu, C, and Mn), and metalloids, at ppm levels. Nonmetal elements can also be tested by ICP-OES, such as Sulfur and Phosphorous. ICP-OES was used to determine the amount of metal present in the protein matrix after blending steps.

The ICP results showed that most of the Zn is retained and detected in the final HSW solids with a good recovery that is close to 92-99%. At 10% inclusions, almost 33-36 g/kg of Zn is present in HSW solid where a minimum of 29 ppm is needed for value-added feed product, such as Sweet Bran (or 58.5 ppm in HSW solids). Similarly, other heavy metals (Cr, Ni, Cu, Mn, & Fe) and minerals (Ca2+, Na+, Mg2+, & K+) have been detected in the HSW matrix at various ppm levels (0.5-13,000 ppm). These metals/minerals can chelate with the HSW protein and be detected with other analytical techniques that are supposed to characterize the Zn-protein interaction mainly.

SEM equipped with an energy-dispersive X-ray spectroscopy (EDS or EDX) showed that at higher Zn-inclusion rate, the zinc levels were found evenly distributed within the matrix of the HSW solids and colocalized with the N elements of the HSW protein. Sulfur element was also uniformly distributed in the solid/protein matrix. Free zinc or sulfate particles were also detected in some minor areas of the images due to excess salt addition. Elemental spectra showed an increase in Zn peak area that corresponds to the Zn-inclusion rate.

Thermal gravimetry (TG) showed stronger and new structures formed upon the addition of higher amounts of zinc metals. As discussed above, the shift is clearly detected in both 5 and 10% Zn-inclusions and carries on to a much higher temperature (in the 500-600° C.), which is indicative of a strong interaction/binding between the Zinc ions and protein/solid matrix of HSW. The weight loss detected between 10° and 150° C. is mainly attributed to the water and other volatiles removal from the samples at starting point.

DSC Analysis (Qualitative has shown to be an efficient technique to determine thermodynamic factors and binding behaviors of metals in protein structure. During the thermal denaturation of the protein at increased temperature the hydrogen bonding is weakened while the hydrophobic network becomes stronger. Herein, the conformational stability of Zn-HSW protein and zinc binding during the thermal denaturation process is detected. It is differentiated from the ZnSO₄·7H₂O salt by the absence of the endothermic dehydration broad peaks between 37 to 55° C. and 60 to 85° C.

When heat flow of the sample is lower than that of the reference, the peaks are in negative direction. The negative and positive heat flows help us to differentiate between glass transition, crystallization, and melting temperatures (Tg, Tc, and Tm, respectively) in the DSC scans. Tc typically has a positive heat flow as it is exothermic and releases energy while the material is solidifying in DSC test, while Tg and Tm have negative heat flows. It is important to note that a complete absence of exothermic crystalline transition was detected in all scans.

Shifting to the right in the transition temperature is indicative of stronger binding while to the left is indicative of weaker binding. The obtained DSC curves also showed that the thermal denaturation of HSW protein depended on the Zn concentration. The higher values of the denaturation enthalpies (AH), compared to HSW controls, showed that HSW protein was stabilized by the chelation with Zn ions.

TABLE 2
Preparation of Zn-HSW product at various inclusion rates (0, 2, 5, & 10%).

| | | % Zn | Zn | ZnSO₄•7H₂O | H₂O | | Solids | | HSW |
|---|---|---|---|---|---|---|---|---|---|
| | Sample | Inc db | (g) | (g) | (g) | Phytase | (g) | % DS | (g) |
| | | | | | | | | 43.0 | 200.0 |
| Source | HSW 1 | 0 | 0 | 0 | 25 | +200 μl | 86.0 | 38.2 | 225.0 |
| 1 | HSW2 | 2.0% | 1.8 | 7.7 | 25 | +200 μl | 93.7 | 40.3 | 232.7 |
| | HSW3 | 5.0% | 4.4 | 19.3 | 25 | +200 μl | 105.3 | 43.1 | 244.3 |
| | HSW4 | 10.0% | 8.8 | 38.7 | 40 | +200 μl | 124.7 | 44.7 | 278.7 |
| | | | | | | | | 42.0 | 200.0 |
| Source | HSW5 | 0.0% | 0 | 0 | 25 | +200 μl | 84.0 | 37.3 | 225.0 |
| 2 | HSW6 | 2.0% | 1.9 | 8.5 | 25 | +200 μl | 92.5 | 39.6 | 233.5 |
| | HSW7 | 5.0% | 4.8 | 21.1 | 25 | +200 μl | 105.1 | 42.7 | 246.1 |
| | HSW8 | 10.0% | 9.6 | 42.3 | 25 | +200 μl | 126.3 | 44.7 | 282.3 |

Zn inc db means Zn inclusion on dry basis.

The PXRD results showed a crystallinity pattern in the Zn-HSW (as compared to control HSW indicating amorphous profile) at higher inclusion rate of Zn metal (5 wt % and 10 wt %) in the centrifuged solids and the as-is samples. The as-is Source 1 HSW showed a very different crystalline profiles as compared to Source 1 HSW when interacting with zinc metals. The peaks (at) 20=28-29° correspond to Zn elements chelated/complexed with HSW proteins. Additional peaks were also unique to zinc at 18 and 23°. The as-is Source 1 HSW showed a strong crystalline profile that might be attributed to the presence of high metal/mineral contents (other than zinc), which may enhance complexation/chelation with HSW proteins.

### Example 2.2

Objective: The aim of this test was to treat HSW from 3 corn wet milling sites with Zn ions at various inclusion rates of 0, 2, and 10 wt % to evaluate the impact of corn wet milling protein on Zn-chelation process.

Materials & Methods: 200 g of liquid HSW samples obtained from 3 corn wet milling sites were prepared to be mixed with ZnSO₄·7H₂O to make one of the 3 inclusions levels of Zn in HSW (0, 2, and 10% on dry basis). A total of 12 portions of HSW were utilized in all treatments. Each portion of HSW was warmed up to 50° C. in water bath after the addition of Optimash phytase (200 μl) to hydrolyze any phytic acid that might chelate with the Zinc metal. ZnSO₄·7H₂O was then mixed with deionized water to facilitate the Zn²⁺ ion dissolution in the HSW portion (all amounts are listed in the Table 2). The Zn solution was then dispensed into the warm HSW in each of the eight containers, mixed well at 150 rpm, and then incubated at 50° C. for one hour with agitation. The samples were tested as-is on ICP-OES and DSC. Portions of the 12 samples were freeze dried at MRDC and tested on PXRD and SEM-EDS.

TABLE 3
Zn and other metals' distributions in HSW of three sites at various Zn inclusions.

| | | | | | | | | | | Post- |
|---|---|---|---|---|---|---|---|---|---|---|
| | | Pre- | | | | | | Post- | | Mix |
| | | Mix | | | | | | Mix | | % Zn |
| | | % Zn | Zn | ZnSO₄ | ZnSO₄•7H₂O | H₂O | Solids | | HSW | Inc |
| Source | No. | Inc db | (g) | (g) | (g) | (g) | (g) | % DS | (g) | db |
| Source | 1 | 0.0% | 0.0 | 0.0 | 0.0 | 25 | 91.4 | 40.6 | 225.0 | 0.0 |
| 3 | 2 | 2.0% | 1.8 | 4.5 | 8.0 | 25 | 95.9 | 41.1 | 233.0 | 1.9 |
| | 3 | 12.0% | 11.0 | 27.1 | 48.2 | 40 | 122.9 | 42.7 | 288.2 | 8.9 |
| Source | 4 | 0.0% | 0.0 | 0.0 | 0.0 | 25 | 89.4 | 39.7 | 225.0 | 0.0 |
| 4 | 5 | 2.0% | 1.8 | 4.4 | 7.9 | 25 | 93.8 | 40.3 | 232.9 | 1.9 |
| | 6 | 12.0% | 10.7 | 26.5 | 47.2 | 40 | 120.3 | 41.9 | 287.2 | 8.9 |
| Source | 7 | 0.0% | 0.0 | 0.0 | 0.0 | 25 | 95.9 | 42.6 | 225.0 | 0.0 |
| 5 | 8 | 2.0% | 1.9 | 4.7 | 8.4 | 25 | 100.6 | 43.1 | 233.4 | 1.9 |
| | 9 | 12.0% | 11.5 | 28.4 | 50.6 | 40 | 129.1 | 44.4 | 290.6 | 8.9 |
| Source | 10 | 0.0% | 0.0 | 0.0 | 0.0 | 25 | 92.0 | 40.9 | 225.0 | 0.0 |
| 2 | 11 | 2.0% | 1.8 | 4.5 | 8.1 | 25 | 96.5 | 41.4 | 233.1 | 1.9 |
| | 12 | 12.0% | 11.0 | 27.3 | 48.6 | 40 | 123.8 | 42.9 | 288.6 | 8.9 |

Similar to Example 2.1, the PXRD results showed a crystallinity pattern in the Zn-HSW (as compared to control HSW) at higher inclusion rate of Zn metal (2% and 10%) in the as-is samples of three corn wet mills. The higher inclusion of Zn in Source 1 HSW showed a crystalline profile as compared to Source 3 and Source 5 HSW, probably due to the interaction of zinc with the biomass protein and lower carbohydrate content in Source 1 HSW. A flatter scan obtained at 10% inclusion (peaks in the region of 2−theta=16-28° indicated a better crystalline arrangement of zinc atoms within the HSW solid matrix as well. Additional peaks were also unique to chelated zinc detected at ~14° and 44°. In most cases (control HSW and Zn-HSW), a peak was detected at ~10°, however as zinc inclusion increased, a slight shift to a higher degree was detected. The Source 4 HSW did not show a significant difference as compared to the Source 3 HSW that contains side streams of other types of fermentations.

SEM images with an energy-dispersive X-ray spectroscopy (EDS or EDX) capability of the metal-protein substrates at nm scale (Zn-HSW from three wet mills at various inclusion levels of 0, 2, and 10%) were acquired. N, S, and Zn were selected for the element mapping and EDS spectral scanning because of their abundance in HSW proteins and zinc sulfate salts. At higher Zn-inclusion rate, the zinc levels were found evenly distributed within the matrix of the HSW solids and colocalized with the N elements of the HSW protein. Sulfur element was also uniformly distributed in the solid/protein matrix. Free zinc or sulfate particles were also detected in some minor areas of the images due to excess salt addition. Elemental spectra showed an increase in Zn peak area that corresponds to the Zn-inclusion rate.

DSC scans of Zn chelated to Source 2, Source 3, and Source 5 HSW proteins at various inclusion rates of 0, 2, and 10% show the conformational stability of Zn-HSW protein and zinc binding during the thermal denaturation process is detected. Zn-HSW samples are separated from the ZnSO₄·7H₂O salt by the absence of the endothermic dehydration broad peaks between 37 to 55° C. and 60 to 85° C. Similarly, a complete absence of exothermic crystalline transition was detected in all scans. This indicates that the HSW protein and solids, once complexed with Zn ions, all together cannot form a totally crystalline structure by itself at increased temperature, while some crystalline latices are formed within the protein solid and gets detected by PXRD. Shifting to the right in the transition temperature is indicative of stronger binding while to the left is indicative of weaker binding (This was the case with the Source 3 Source 4 and Source 5 HSW but not in Source 2 HSW). The absence of shift in transition temperature in Source 2 HSW is consistent with Example 2.1 and might be due to the complete absence of sugar, however, it is indicating a slight weaker bonding with similar transition temperature to control. The obtained DSC curves also showed that the thermal denaturation of HSW protein depended on the Zn concentration. The higher values of the denaturation enthalpies (AH), compared to HSW controls, showed that HSW protein was stabilized by the chelation with Zn ions (this was the case in Source 5 and Source 2 HSW).

### Example 3: Preparation of Zn-E75 and Zn-HSW (on Germ Carriers) Chelated Prototypes

Objective: The objective of this example is to produce Zn-proteinate prototypes at 12% inclusions. The following set of samples were prepared and utilized in the Broiler trial (using various ingredients):
Control E75 and 40%-HSW/E75 (for the analytical part)
MinPro #1:12 wt % inclusion of Zn in Source 5 Empyreal 75
MinPro #2 & 6:12 wt % inclusion of Zn in Source 2 Heavy Steep and utilizing Source 5 solvent extracted meal as a carrier.

Materials and Methods: Using the optimized blending and drying conditions, two types of final prototypes were made to assess in situ bioavailability. A Zn inclusion of 12% was targeted for this trial in both types, E75 to make MinPro #1 and HSW to make MinPro #2 & 6 (as illustrated in Tables 4a and 4b). When trialing the incorporation of Zn into heavy steep protein, Source 5 E75 or solvent extracted meal was utilized as a carrier, but only the one with solvent extracted corn germ meal carrier was utilized in the Broiler feeding stage, and both were characterized. Other carriers, such as dry E75 product, milled dry bran, and dry starch, were also used and corresponding MinPros were manufactured but not fully characterized.

The HSW dry basis inclusion was maintained at 40% onto the solvent extracted corn germ meal carrier with a 12% inclusion (Tables 4a and 4b). Source 2 heavy steep was utilized as it contains 100% of ethanol biomass without any substantial presence of leftover monosaccharide sugars. The six wet protypes (MinPro 1-6) were made but only three were dried in FBD (at 40° C., for approx. 30 min and maximum air flow), then ground in a coffee grinder to make the final products (MinPro 1, 2, & 6) for further characterization. Only about 300 g of final dry product (MinPro #1 & #6) was sent to University of Illinois for evaluation in a broiler feeding study. The remaining about 50 g of MinPro 1 & 6 were tested on ICP-OES, PXRD, SEM-EDX, and DSC.

TABLE 4a
Production of 3 MinPro prototypes -- ingredients.
Sample Preparation

| | Ingredient 1 | | | | Ingredient 2 | | | | Ingredient 3 | | | | |
|---|---|---|---|---|---|---|---|---|---|---|---|---|---|
| | Source 5 E75 Wet Cake | | | | Source 2 HSW | | | | | | | Zn | Ingre- |
| | | | | % | | | | % | | | | % | dient 4 |
| | AF | % | DB | DB | AF | % | DB | DB | ZnSO₄•7H₂O | ZnSO₄ | Zn | DB | Water |
| | (g) | DM | (g) | incl. | (g) | DM | (g) | incl. | (g) | (g) | (g) | incl. | (g) |
| Min | 625.0 | 40.0 | 250.2 | 60% | — | — | — | — | 132.0 | 74.1 | 30.0 | 12.0 | 158.4 |
| Pro | | | | | | | | | | | | | |
| #1 | | | | | | | | | | | | | |
| Min | 375.0 | 40.0 | 150.1 | | 208.0 | 48.1 | 100.1 | 40% | 132.0 | 74.1 | 30.0 | 12.0 | 158.4 |
| Pro | | | | | | | | | | | | | |
| #2 | | | | | | | | | | | | | |
| Min | 170.0 | 91.0 | 154.7 | 60% | 214.4 | 48.1 | 103.1 | 40% | 136.1 | 76.4 | 30.9 | 12.0 | 0.0 |
| Pro | | | | | | | | | | | | | |
| #6 | | | | | | | | | | | | | |

TABLE 4b
Production of 3 MinPro prototypes-blends and products.
Broiler Trial Preparation

| | Blends and Products | | | | |
|---|---|---|---|---|---|
| | Predry AF | Water | Predry solids | Predry solids | Post FBD |
| | (g) | (g) | (g) | % DM | (g) |
| MinPro #1 | 915.4 | 591.2 | 324.3 | 35.4 | 356.4 |
| MinPro #2 | 873.5 | 549.2 | 324.3 | 37.1 | 356.4 |
| MinPro #6 | 520.5 | 186.2 | 334.4 | 64.2 | 367.3 |

The ICP results showed that most of the Zinc is retained and detected in the final Zn-E75 (MinPro #1) and Zn-HSW (MinPro #2 & #6) solids with a final Zn inclusion of about 9.4 wt % on dry basis (Table 5) where a minimum of 29 ppm is needed for value-added feed product, such as Sweet Bran (or 58.5 ppm in HSW solids). Similarly, other heavy metals (Cr, Ni, Cu, Mn, & Fe) have been detected in both E75 and HSW matrices at various ppm levels (0.4-100 ppm). These metals (and other minerals, not listed in the table, such as Ca, K, Mg, and Na) can chelate with the HSW protein, for example, and be detected with other analytical techniques that are supposed to characterize the Zn-protein interaction mainly.

TABLE 5
Zn and other metal distributions in E75 and HSW (on two carriers, solvent extracted meal or E75).

| | | | | | | | | Measured | Predicted | | | | | |
|---|---|---|---|---|---|---|---|---|---|---|---|---|---|---|
| | | Co | Cr | Cu | Fe | Mn | Zn | Zn | Zn | % | % | color | | |
| | Sample | mg/kg | mg/kg | mg/kg | mg/kg | mg · kg | mg/kg | % d.b. inc | % d.b. inc | moisture | protein | L | a | b |
| Zn-E75 | MinPro #1 | <0.2 | 0.46 | 14 | 28 | 2 | 84212 | 9.37 | 9.26 | 10.29 | 56.4 | 82.4 | 8.5 | 49.3 |
| Zn- | MinPro #6 | <0.2 | 0.37 | 8 | 64 | 11 | 82441 | 9.14 | 9.26 | 9.87 | 48.0 | 55.0 | 10.6 | 30.5 |
| HSW- | | | | | | | | | | | | | | |
| SEM | | | | | | | | | | | | | | |
| Zn- | MinPro #2 | <0.2 | 0.61 | 12 | 47 | 9 | 87976 | 9.60 | 9.26 | 8.54 | 44.4 | 76.5 | 10.0 | 49.0 |
| HSW- | | | | | | | | | | | | | | |
| E75 | | | | | | | | | | | | | | |
| E75 | MinPro #1 | <0.2 | 0.47 | 13 | 33 | 2 | 182 | | | 10.32 | 73.5 | 79.5 | 10.9 | 51.3 |
| | Control | | | | | | | | | | | | | |
| HSW- | MinPro #6 | <0.2 | 0.60 | 7 | 82 | 14 | 93 | | | 8.74 | 64.8 | 55.7 | 10.5 | 29.9 |
| SEM | Control | | | | | | | | | | | | | |
| HSW- | MinPro #2 | <0.2 | 0.60 | 13 | 59 | 12 | 129 | | | 9.60 | 59.8 | 77.2 | 9.7 | 49.4 |
| E75 | Control | | | | | | | | | | | | | |

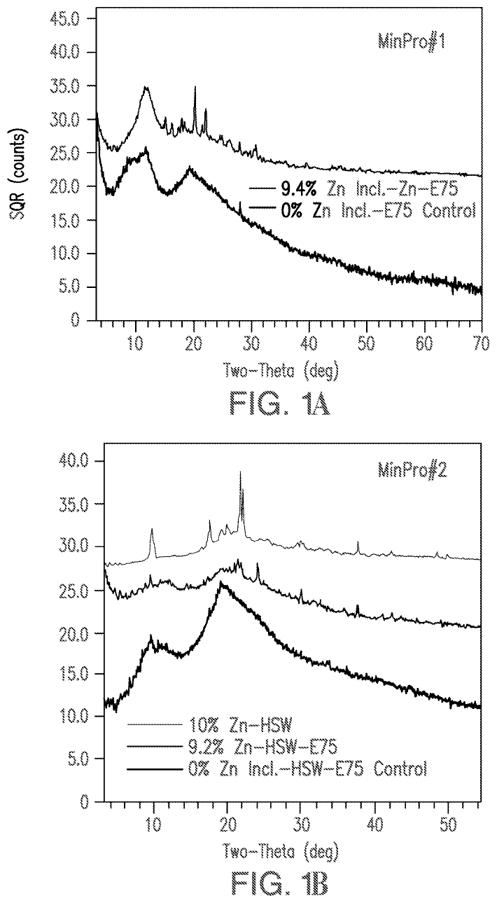

The PXRD results showed a development of new crystallinity patterns in both Zn-E75, MinPro #1, and Zn-HSW, MinPro #2 & #6 (as compared to controls, E75 and HSW. PXRD patterns of MinPro #1 Zn-E75 and MinPro #2 & 6 (both at 0 and 9.4% Zn inclusion) are shown in FIGS. 1A-1C. The E75 matrix chelated extremely well with Zn and generated multiple peaks at 2−theta between 1° and 30°. The as-is Source 2 HSW showed a slightly different crystalline profile when interacting with zinc metals on two different carriers (E75 vs. solvent extracted meal). The highlighted peaks (at 2−theta=23°) correspond to Zn elements chelated/complexed with HSW proteins in both cases. Additional peaks were also unique to zinc at 16° (in the solvent extracted meal carrier case).

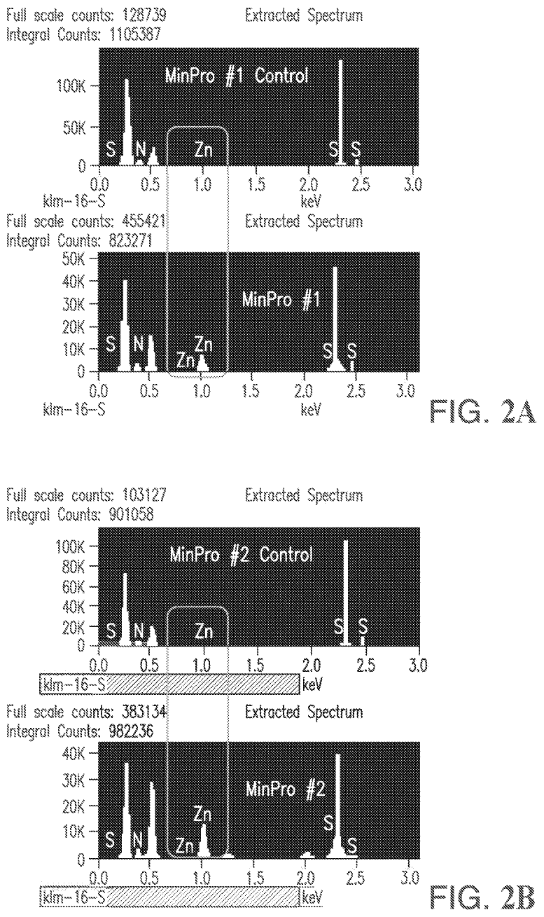

SEM equipped with EDS was utilized to image and analyze the elemental composition of the metal-protein substrates at nanometer scale in Zn-E75, MinPro #1, and Zn-HSW, MinPro #2 & #6 (as compared to controls, E75 and HSW). SEM-EDS spectra of MinPro #1 Zn-E75 and MinPro #2 & 6 Zn-HSW-E75 (both at 0 and 9.4% Zn inclusion) are presented in FIGS. 2A-2C. N, S, and Zn were selected for the element mapping and EDS spectral scanning as N is a major element in E75 and HSW protein, Zn in the zinc sulfate salt, and S as the common element in both protein (from E75 or HSW) and zinc sulfate salt. As shown in FIGS. 3A-3C, the zinc levels were found evenly distributed within the matrix of both E75 and HSW solids at higher Zn-inclusion rate and colocalized with the N elements of their proteins. Sulfur element was also uniformly distributed in the solid/protein matrix. Elemental spectra (FIGS. 2A-2C) showed an increase in Zn peak area that corresponds to the Zn-inclusion rate.

DSC is used here to determine thermodynamic factors and binding behaviors of metals in protein structure (Zn atoms in Source 2 HSW and E75 proteins at high inclusion rates of 0 and 10%). During DSC analysis of the protein at increased temperature, the conformational stability of Zn-proteinate and zinc binding is detected. It is differentiated from the ZnSO₄·7H₂O salt by the absence of the endothermic dehydration broad peaks between 37 to 55° C. and 60 to 85° C.

A complete absence of exothermic crystalline transition and endothermic glass transition with an appearance of an endothermic melting transition (with negative heat flow peak) were detected in all scans.

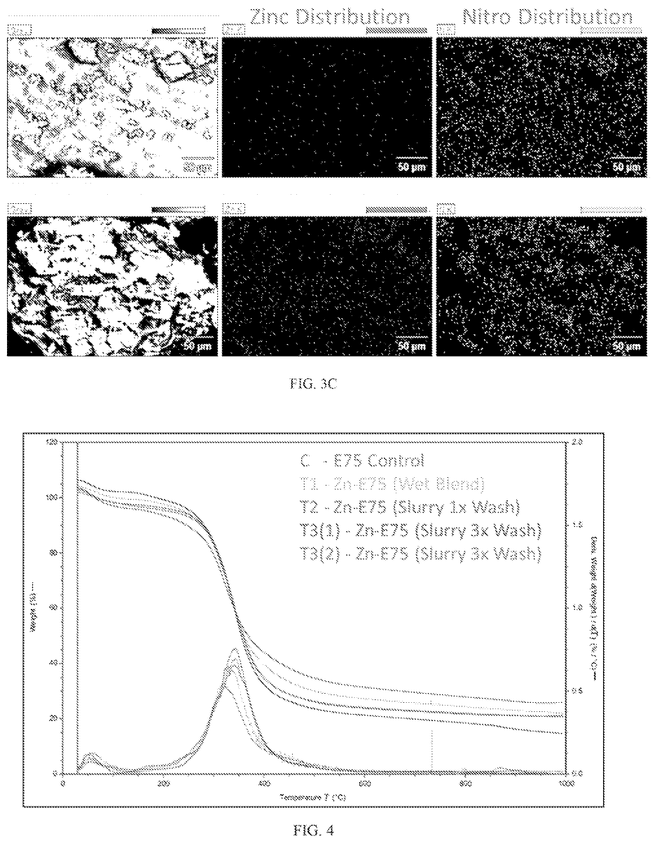

Shifting the to the right in the transition temperature is indicative of stronger binding while to the left is indicative of weaker binding (A shift to the right was observed with the MinPro #1 & #2 prototypes, where a stronger bond between Zn and protein/solid was formed). As shown in FIG. 6, the obtained DSC curves of three Zn-proteinates showed higher absolute values of enthalpies (ΔH), compared to controls, which indicates that E75 and HSW (on two carriers) proteins were stabilized by the chelation with Zn ions.

The findings are summarized as follows: SEM-EDS showed that zinc was evenly distributed within the matrix of the E75 solids and colocalized with the N elements of the E75 protein. TG analysis showed a shift to a higher decomposition temp, indicating stronger and new structures formed at higher inclusion of zinc in E75. Conformational stability of Zn-E75 protein and zinc binding during the thermal denaturation process is detected by DSC. Three Zn-proteinate prototypes (on Zn-E75 and two Zn-HSW on two different carriers, E75 or solvent extracted meal) at 12% inclusions were manufactured & characterized. The two prototypes achieved similar characteristics reported in the previously screened samples.

### Example 4: HSW-Zn and Empyreal 75-Zn Bioavailability Tests

### Prototypes:

Briefly, prototypes consisting of Zn-chelated heavy steep water (HSW-Zn) and Empyreal 75-Zn (a corn protein concentrate with chelated zinc) were prepared as described herein to create a 12 wt % Zn concentrate chelate. Heavy steep water-Zn conjugates were dried on to solvent extracted germ meal for ease of mixing into the feed formulation.

### Bioavailability Trial:

New Hampshire×Columbian male and female chicks from the University of Illinois Poultry Field Laboratory were fed a nutritionally complete corn-soybean meal diet for the first 3 days post-hatching. The chicks were then switched to a Zn-deficient soy concentrate basal diet and fed this diet until 1600 h on D 7 post-hatching. After being subjected to overnight feed withdrawal, chicks were weighed, wing banded and allotted to pens so that each pen has a similar initial weight. Treatment additions were made at the expense of cornstarch. The trial diet can be seen in Table 6.

Five replicate groups of four chicks were fed one of 10 diets for 14 d (Day 8-22 post-hatch). Chicks were maintained in heated stainless-steel batteries and exposed to constant fluorescent light. The dietary treatments are listed below:
1. Basal soy concentrate diet-Zn deficient (13-14 mg/kg Zn)
2. As 1+3 mg/kg Zn from feed grade ZnSO₄·7H₂O
3. As 1+6 mg/kg Zn from feed grade ZnSO₄·7H₂O
4. As 1+9 mg/kg Zn from feed grade ZnSO₄·7H₂O
5. As 1+3 mg/kg Zn from Organic Zn prototype MinPro-E75
6. As 1+6 mg/kg Zn from Organic Zn prototype MinPro-E75
7. As 1+9 mg/kg Zn from Organic Zn prototype MinPro-E75
8. As 1+3 mg/kg Zn from Organic Zn prototype MinPro-HSW
9. As 1+6 mg/kg Zn from Organic Zn prototype MinPro-HSW
10. As 1+9 mg/kg Zn from Organic Zn prototype MinPro-HSW

TABLE 6
Basal diet formulation used during the
Zn depletion phase of the study.

| Basal Diet Ingredients | wt % |
|---|---|
| Soy Concentrate (63.9% CP) | 31.00 |
| Dextrose | 36.9155 |
| Cornstarch* | 21.00 |
| Soybean Oil | 5.00 |
| Zn-free glista salts | 5.37 |
| DL-Methionine | 0.20 |
| L-Threonine | 0.10 |
| Purified Vitamin Mix | 0.20 |
| Choline Chloride (99%) | 0.20 |
| DL-tocopheryl acetate | 0.002 |
| Ethoxiquin | 0.0125 |

*Zinc compounds added in place of starch.

Chicks were weighed at the beginning and the end of the trial and weight gain calculated by subtracting the starting weight from the ending weight. Feed intakes were calculated via subtracting the feed refusals from the feed provided, with Zn intakes calculated based on Zn concentration in the diet and total feed consumed. Feed conversions were determined by using the feed consumed divided by weight gained.

Upon termination of the experiment, chicks and feeders were weighed and chicks were euthanized with CO₂ gas. The right tibia from each chick was removed and pooled by replicate pen. The tibia was then autoclaved and cleaned to remove all adhering tissue, dried at 110° C. for 24 h, and then dry ashed in a muffle furnace. The ash was analyzed for Zn at the University of Missouri. Bioavailability of Zn was then determined by the slope-ratio method using multiple regression analysis. Weight gain, tibia Zn concentration and total tibia Zn were regressed on supplemental Zn intake from the Zn sources and the bioavailability of the Zn in the Zn-protein sources was calculated relative to the Zn in ZnSO₄·7H₂O.

### Chick Performance Measures:

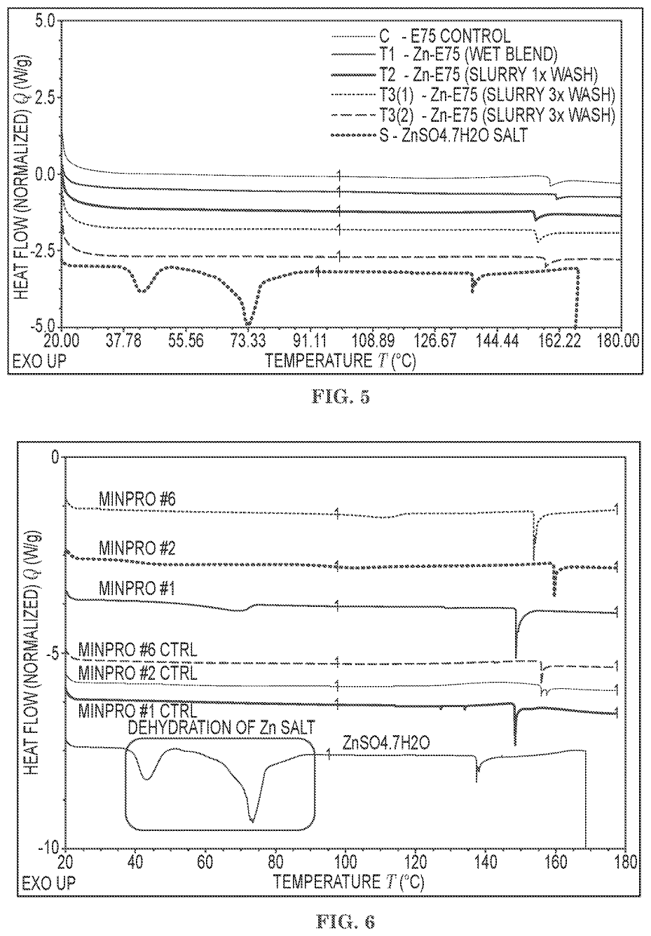

Initial average weights, 8-day weights at the beginning of the trial, were 99.0 g and 93.9 g for the male and female chicks, respectively. Two male and 2 female chicks were used per pen for the trial. Cumulative feed intake was determined over the course of the trial with the negative control chick receiving the Zn-deficient diet consuming 304.7 g/chick. This was significantly less compared to all of the Zn supplement diets, regardless of the treatment or levels of prototype being fed (FIG. 7). As can be seen in FIG. 7, as the levels of Zn increased in the diet, the amount of intake also increased regardless of treatment. Within level of Zn inclusion in the diet there was not significant difference between treatments.

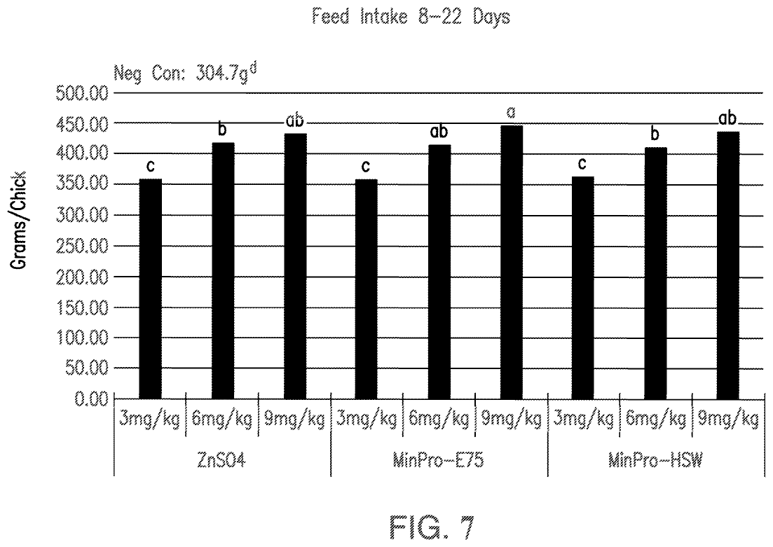

Chicks receiving the Zn-deficient diet gained 145.2 g over the course of the study period which was significantly less (P≤0.05) compared to the Zn supplement groups regardless of Zn inclusion or Zn source. Similar to the intakes, as Zn inclusion in the diet went up, there was a significant increase in weight gain from 3 mg/kg to 6 mg/kg inclusion (FIG. 8). There were no significant differences in weight gain between Zn-types.

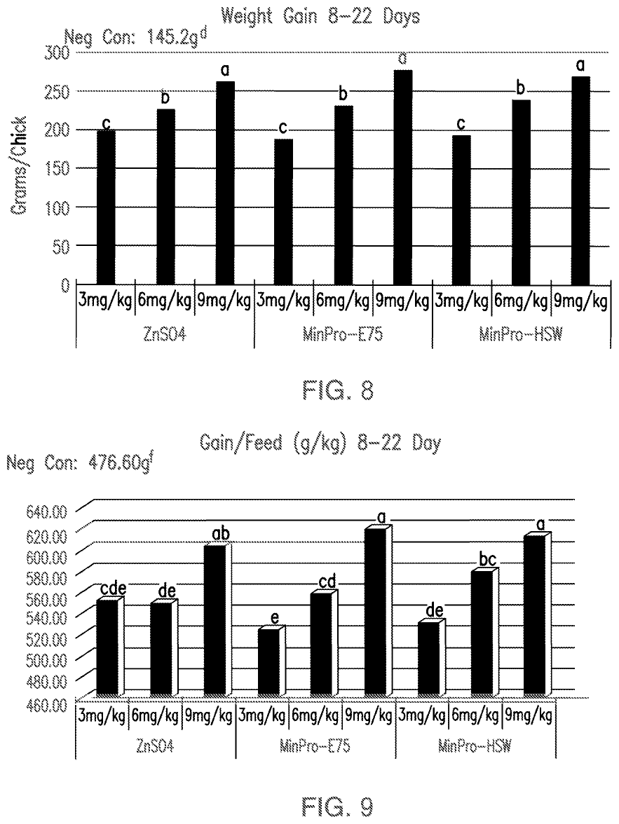

Feed conversion comparisons of prototypes and inclusion in the diet can be seen in FIG. 9. As can be expected, conversions for the negative control were significantly lower than that of the prototype treatment groups regardless of level of Zn inclusion. There were no significant differences between type of Zn fed and the inclusion. As in the feed intake and weight gain, as the Zn levels increased there was a marked difference on feed conversion, with the exception of the ZnSO₄ positive control. Zinc inclusion at 3 mg/kg and 6 mg/kg had similar feed efficiency in the positive control at approximately 560 g/kg of feed consumed. Both MinPro prototypes demonstrated a stepwise difference in conversion with the 6 mg/kg Zn inclusion being higher.

### Zinc Impact on Bone Measures:

Feed Impacts of Zn inclusion in the diet are shown in Table 7. There was no observable impact from Zn type on dry bone weight, bone ash weight or percent bone ash. As Zn levels increased in the diet, as well as increase in feed consumption with these higher levels, these parameters significantly increased, and all Zn inclusion levels were significantly higher than the negative control. Likewise, as Zn supplementation increased in the diet, Zn levels in the tibia exhibited an increase. Although not significantly different, the MinPro-E75 and MinPro-HSW showed numerical increases in Zn concentration in comparison to that of the ZnSO₄ positive control.

TABLE 7
Measurement of tibia weight, ash weight and Zn concentration based on intake of Zn inclusion.

| | | ZnSO₄ | ZnSO₄ | ZnSO₄ | E75 | E75 | E75 | HSW | HSW | HSW |
|---|---|---|---|---|---|---|---|---|---|---|
| | Neg | 3 | 6 | 9 | 3 | 6 | 9 | 3 | 6 | 9 |
| | Con | mg/kg | mg/kg | mg/kg | mg/kg | mg/kg | mg/kg | mg/kg | mg/kg | mg/kg |
| Dry Bone Wt (mg/tibia) | 859^{f} | 1012^{e} | 1104^{bdc} | 1176^{ab} | 1009^{a} | 1083^{cde} | 1176^{ab} | 1026^{de} | 1118^{abc} | 1197^{a} |
| Bone Ash Wt (mg/tibia) | 348^{f} | 433^{de} | 478^{bc} | 515^{ab} | 426^{a} | 472^{cd} | 523^{a} | 434^{de} | 484^{abc} | 521^{aa} |
| Bone Ash (%) | 40.6^{e} | 42.8^{bcd} | 43.4^{abcd} | 43.8^{ab} | 42.2^{d} | 43.6^{abc} | 44.5^{a} | 42.3^{cd} | 43.4^{abcd} | 43.5^{abc} |
| Supplemental Zn Intake (mg) | 0^{d} | 1.08^{e} | 2.44^{b} | 3.90^{a} | 1.07^{c} | 2.49^{b} | 4.02^{a} | 1.09^{c} | 2.48^{b} | 3.95^{a} |
| Tibia Ash Zn Conc. | 75.3^{f} | 79.16^{ef} | 88.98^{cd} | 101.2^{ab} | 81.56^{def} | 94.3^{bc} | 106.4^{a} | 84.0^{de} | 93.2^{bc} | 107.2^{a} |
| (μg/g of ash) | | | | | | | | | | |

^{abcdef}Superscripts with different letters within row are significantly different (P ≤ 0.05)

### Zinc Bioavailability Determination:

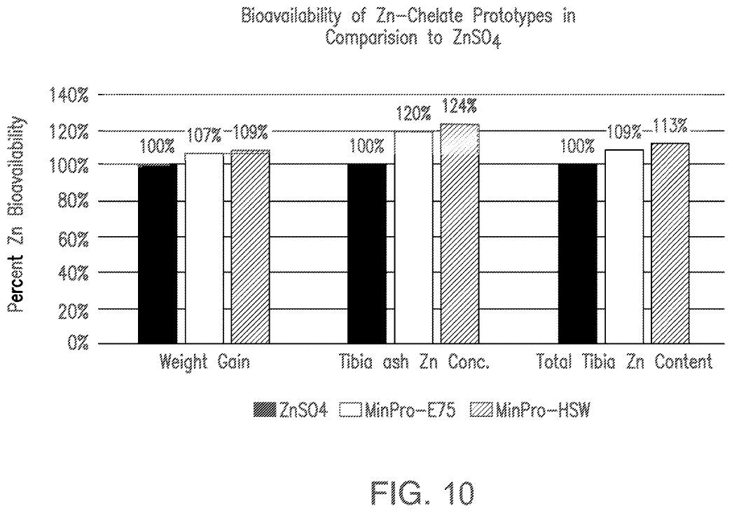

Zinc bioavailability was determined according to the method reported by Wedekind, et al., J. Anim. Sci 70:178-187 (1992). The slope ratio method was used to compare the different Zn prototypes to a positive control, ZnSO₄. By increasing the Zn concentration in the diet, the slope ratio method can predict the % bioavailability based on standard curve for that Zn type. In this work, the Zn bioavailability for ZnSO₄ was set as the standard at 100% bioavailable. With the y intercept being the same between the positive control and the different levels plotted across x, the slope m can determine if there is a difference between the Zn prototypes and the positive control. The equations and relative bioavailability to ZnSO₄ using response parameters of weight gain, tibia ash Zn concentration and total tibia Zn can be seen in equations 1, 2 and 3, respectively. Using weight gain as the response parameter, the relative bioavailability of MinPro-E75 and MinPro-HSW was 107% and 109%, respectively (FIG. 10). Increased bioavailability was also seen using response parameters of tibia ash Zn concentration and total tibia Zn. For each of these parameters, MinPro-E75 improved 120% and 109% while MinPro-HSW improved 124% and 113% in comparison to the inorganic Zn source, respectively.

### Equations:

1. Using chicks' body weight gain (g) as a response parameter, multiple linear regression was found to be:

$$Y = 156.2 + ( 28.00 \pm 1.64 ) {X}_{1} + ( 30.06 \pm 1.59 ) {X}_{2} + ( 30.40 \pm 1.62 ) {X}_{3}$$

$${R}^{2} = 0.92$$

Y=Chicks' body weight gain (g)
X₁=Intake of supplemental Zn (FG ZnSO₄)
X₂=Intake of supplemental Zn (MinPro-E75)
X₃=Intake of supplemental Zn (MinPro-HSW)

### Relative Bioavailability to Standard (RG ZnSO₄)

$$Relative Bioavailability value of FG {ZnSO}_{4} = 28. / 28. = 1 * 100 = 100 \%$$

$$Relative Bioavailability value of MinPro - E 75 = 30.06 / 28. = 1.07 * 100 = 107 \%$$

$$Relative Bioavailability value of MinPro - HSW = 30.4 / 28. = 1.09 * 100 = 109 \%$$

Using tibia ash Zn concentration (ug/g of bone ash) as a response parameter, multiple linear regression was found to be:

$$Y = 73.4 + ( 6.81 \pm 0.75 ) {X}_{1} + ( 8.18 \pm 0.73 ) {X}_{2} + ( 8.42 \pm 0.74 ) {X}_{3}$$

$${R}^{2} = 0.80$$

Y=tibia ash Zn concentration (ug/g of bone ash)
X₁=Intake of supplemental Zn (FG ZnSO₄)
X₂=Intake of supplemental Zn (MinPro-E75)
X₃=Intake of supplemental Zn (MinPro-HSW)

### Relative Bioavailability to Standard (RG ZnSO₄)

$$Relative Bioavailability value of FG {ZnSO}_{4} = 6.81 / 6.81 = 1 * 100 = 100 \%$$

$$Relative Bioavailability value of MinPro - E 75 = 8.18 / 6.81 = 1.2 * 100 = 120 \%$$

$$Relative Bioavailability value of MinPro - HSW = 8.42 / 6.81 = 1.23 * 100 = 124 \%$$

Using Total Tibia Zn (ug/tibia) as a response parameter, multiple linear regression was found to be:

$$Y = 26.8 + ( 6.59 \pm 0.40 ) {X}_{1} + ( 7.16 \pm 0.39 ) {X}_{2} + ( 7.46 \pm 0.39 ) {X}_{3}$$

$${R}^{2} = 0.92$$

Y=Total Tibia Zn (ug/tibia)
X₁=Intake of supplemental Zn (FG ZnSO₄)
X₂=Intake of supplemental Zn (MinPro-E75)
X₃=Intake of supplemental Zn (MinPro-HSW)

### Relative Bioavailability to Standard (FG ZnSO₄)

Relative Bioavailability value of FG ZnSO₄=6.59/6.59=1*100=100%.
Relative Bioavailability value of MinPro-E75=7.16/6.59=1.09*100=109%.
Relative Bioavailability value of MinPro-HSW=7.46/6.59=1.13*100=113%

This example tested two prototypes of Zn-proteinates using co-products derived from the corn wet milling process. Based on this work, it was determined that both the MinPro-E75 and MinPro-HSW had increased levels of bioavailability as measured by the slope-ratio method using body weight gain, tibia Zn concentration to total tibia Zn as the response parameter. Wedekind, et al., J. Anim. Sci 70:178-187 (1992) demonstrated the bioavailability of a Zn-methionine complex (Zinpro Corporation, Chaska, MN) and found that the bioavailability as measured by tibia Zn concentration was 117% of the positive control, ZnSO₄. By contrast, the prototypes for E75 and HSW were 120% and 124%, respectively. The prototypes developed have improved bioavailability versus the known studies.

### Exemplary Aspects

Further, the disclosure comprises additional notes and examples as detailed in the following clauses set forth below.
Clause 1. A nutritional composition comprising:
(i) one or more of trace metals selected from zinc, manganese, cobalt, copper, and chromium; and
(ii) a milled corn product; wherein up to 75 wt % of the trace metal is chelated or complexed within the milled corn product on a dry weight basis, and
the amount of trace metal is about 0.025 wt % to about 12 wt % of the nutritional composition product on a dry weight basis;
the amount of protein is about 18 to about 83 wt % of the nutritional composition on a dry weight basis.
Clause 2. The nutritional composition of clause 1, wherein the milled corn product is wet milled.
Clause 3. The nutritional composition of clause 1 or clause 2, wherein the milled corn product comprises at least one of corn protein concentrate, corn protein isolate, steep water, gluten slurry, liquified gluten, and a fermented corn product.
Clause 4. The nutritional composition of any one of clauses 1-3, wherein the milled corn product is corn protein concentrate that comprises:
about 55 wt % to about 80 wt % corn protein on a dry weight basis;
a “L” color value between about 60 and about 80;
a phosphorous content between about 0.2 wt % and 0.5 wt % and a sulfur content between about 0.8 wt % and about 1.2 wt %, on dry weight basis; and
a carbohydrate content between about 8 wt % and 21 wt % on dry weight basis.
Clause 5. The nutritional composition of any one of clauses 1-4, wherein the corn protein concentrate comprises one or more of free amino acids, peptides, oligopeptides, proteinaceous species with specific binding sites towards the trace metals, and free or bonded glycine amino acid.
Clause 6. The nutritional composition of any one of clauses 1-5, wherein the milled corn product is heavy steep water that comprises:
a biomass sourced from an ethanol yeast fermentation, lactobacillus fermentation, or a combination of both;
about 28 wt % to about 42 wt % corn protein on a dry weight basis;
a phosphorous content between about 1.6 wt % and about 2.8 wt % and a sulfur content between about 0.3 wt % and about 0.8 wt % on dry weight basis;
a soluble carbohydrate content between about 12 wt % and 24 wt % on dry weight basis; and
an organic acid content-between about 16 wt % and about 32 wt % on dry weight basis.
Clause 7. The nutritional composition of any one of clauses 1-6, wherein the heavy steep water comprises one or more of free amino acids, peptides, oligopeptides, proteinaceous species with specific binding sites towards trace metals and free or bonded glycine amino acid.
Clause 8. The nutritional composition of any one of clauses 1-7, wherein the amount of trace metal is about 0.05 wt % to about 10 wt % of the nutritional composition on a dry weight basis.
Clause 9. The nutritional composition of any one of clauses 1-8, wherein up to 90 mol % of the trace metal is chelated or complexed.
Clause 10. The nutritional composition of any one of clauses 1-9, wherein the trace metal is uniformly distributed within the protein.
Clause 11. The nutritional composition of any one of clauses 1-10, wherein the bioavailability of trace metal is at least 105% when compared to unchelated trace metal.
Clause 12. The nutritional composition of any one of clauses 1-11 that additionally comprises corn germ meal as a trace metal-protein carrier.
Clause 13. The nutritional composition of any one of clauses 1-12, wherein the bioavailability of trace metal is about 105% to about 130% when compared to unchelated trace metal; preferably wherein bioavailability of the trace metal is determined according to the slope ratio method relative to the bioavailability of trace metal salt using response parameters of weight gain, tibia ash concentration of the trace metal, and total trace metal in the tibia.
Clause 14. A food product comprising a nutritional composition of any one of clauses 1-13.
Clause 15. A method of producing a metal chelated milled corn product comprising:
contacting at least one milled corn product with a salt comprising a metal selected from zinc, manganese, cobalt, copper, and chromium in the presence of water to produce the metal chelated milled corn product; and
removing at least a portion of the water from the metal chelated milled corn product.; wherein the amount of water is about 26 wt % to about 88 wt % prior to removing at least a portion of water from the metal chelated milled corn product.
Clause 16. The method of clause 15, further comprising contacting the milled corn product with one or more of carbohydrases, proteases, and phytases.
Clause 17. The method of clause 15 or clause 16, wherein contacting the milled corn product with one or more of carbohydrases, proteases, and phytases occurs prior to contacting the milled corn product with the salt comprising a metal.
Clause 18. The method of any one of clauses 15-17, wherein contacting the milled corn product with one or more of carbohydrases proteases, and phytases occurs after contacting the milled corn product with the salt comprising a metal.
Clause 19. The method of any one of clauses 15-18, wherein the carbohydrase comprises alpha amylase, dextrinase, pullulanase, glucoamylase, hemicellulase, cellulase, and mixtures thereof.
Clause 20. The method of any one of clauses 15-19, wherein the salt is selected from sulfate or halide salts of zinc, manganese, cobalt, copper, and chromium.
Clause 21. A method of producing a metal chelated milled corn product comprising:
wet milling one or more corn protein-containing materials to produce at least one corn protein concentrate and at least one aqueous stream;
separating the protein concentrate from the aqueous stream;
forming heavy steep water from the aqueous stream;
contacting at least one of the corn protein concentrate and the heavy steep water with a salt comprising a metal selected from zinc, manganese, cobalt, copper, and chromium to produce the metal chelated milled corn product.
Clause 22. The method of clause 21, further comprising contacting the milled corn product with one or more of carbohydrases, proteases, and phytases.
Clause 23. The method of clause 21 or clause 22, wherein the protease generates free amino acids, peptides, oligopeptides, and polypeptides that chelate with metals.
Clause 24. The method of any one of clauses 21-23, wherein the phytase generates bioavailable phosphorus and reduce the hindrances between phytates and trace metals while allowing an enhanced contact between the metal and the protein matrix.
Clause 25. The method of any one of clauses 22-24, wherein contacting the milled corn product with one or more of carbohydrases, proteases, and phytases occurs prior to contacting the milled corn product with the salt comprising a metal.
Clause 26. The method of any one of clauses 22-24, wherein contacting the milled corn product with one or more of carbohydrases, proteases, and phytases occurs after contacting the milled corn product with the salt comprising a metal.
Clause 27. The method of any one of clauses 22-26, wherein the carbohydrase comprises alpha amylase, dextrinase, pullulanase, glucoamylase, hemicellulase, cellulase, and mixtures thereof.
Clause 28. The method of any one of clauses 21-27, wherein a solid metal chelated milled corn product is obtained from the heavy steep water that was contacted with the salt comprising the metal compound.
Clause 29. The method of any one of clauses 21-28, wherein the amount of metal in the metal chelated milled corn product is about 0.025 wt % to about 12 wt % metal on a dry weight basis.
Clause 30. The method of any one of clauses 21-29, wherein the amount of metal in the metal chelated milled corn product is about 0.05 wt % to about 10 wt % metal on a dry weight basis.
Clause 31. The method of any one of clauses 21-30, wherein the salt is a water-soluble salt of zinc, manganese, cobalt, copper, and chromium; preferably wherein the salt comprises one or more sulfate or halide salts of zinc, manganese, cobalt, copper, and chromium.
Clause 32. The method of any one of clauses 21-31, wherein the salt comprises one or more of ZnSO₄·7H₂O, MnSO₄·7H₂O, CuSO₄·5H₂O, CoSO₄·7H₂O, and CoCO₃·6H₂O.
Clause 33. The method of any one of clauses 21-32, wherein up to 90 mol % of the metal in the metal chelated milled corn product is chelated.
Clause 34. The method of any one of clauses 21-33, wherein the corn protein concentrate comprises:
about 55 wt % to about 80 wt % corn protein on a dry weight basis;
an “L” color value between about 80 and about 90, that is lighter than the zinc-free CPC;
a phosphorous content between about 0.2 wt % and 0.4 wt % on as-is basis, of which >75% are in free, bioavailable form; and
a sulfur content between about 1.0 and about 5.4% (at maximum zinc inclusion) on as-is basis, of which >85% are in a sulfate form.
Clause 35. The method of any one of clauses 21-34, wherein the heavy steep water comprises:
(i) a biomass sourced from an ethanol yeast fermentation, lactobacillus fermentation, or a combination of both;
(ii) 28%-42% corn protein on a dry weight basis;
   a phosphorous content between about 1.6 wt % and about 2.8 wt % on as-is basis, of which >75% are in free, bioavailable form;
(iii) a sulfur content between about 0.3 wt % and about 2.0 wt % (at maximum zinc inclusion) on as-is basis, of which >85% are in a sulfate form;
(iv) a soluble carbohydrate content between about 12 wt % and about 24 wt % on dry weight basis; and
(v) an organic acid content between about 16 wt % and about 32 wt % on dry weight basis.
Clause 36. An animal feed comprising 0.0001 wt % to 0.8500 wt % of a nutritional composition, the nutritional composition comprising:
(i) one or more of trace metals selected from zinc, manganese, cobalt, copper, and chromium based on total weight of the animal feed; and
(ii) a milled corn product comprising protein; wherein up to 75 wt % of the trace metal is chelated or complexed within the milled corn product on a dry weight basis;
wherein the amount of trace metal is about 0.025 wt % to about 12 wt % of the nutritional composition product on a dry weight basis; and
the amount of protein is about 18 wt % to about 83 wt % of the nutritional composition on a dry weight basis.
Clause 37. The animal feed of clause 36, wherein the amount of the nutritional composition in the animal feed product is 0.0030 wt % to 0.0300 wt %.
Clause 38. The animal feed of clause 36 or clause 37, wherein the milled corn product is wet milled.
Clause 39. The animal feed of any one of clauses 36-38, wherein the milled corn product comprises at least one of corn protein concentrate, corn protein isolate, steep water, gluten slurry, liquified gluten, and a fermented corn product.
Clause 40. The animal feed of any one of clauses 36-39, wherein the milled corn product is corn protein concentrate that comprises:
(i) about 55 wt % to about 80 wt % corn protein on a dry weight basis;
(ii) a “L” color value between about 60 and about 80;
(iii) a phosphorous content between about 0.2 wt % and 0.5 wt % and a sulfur content between about 0.3 wt % and about 0.8 wt % on dry weight basis;
(iv) about 0.8 wt % and about 1.2 wt %, on dry weight basis; and
(v) a carbohydrate content between about 8 wt % and about 21 wt % on dry weight basis.
Clause 41. The animal feed of any one of clauses 36-40, wherein the corn protein concentrate comprises one or more of free amino acids, peptides, oligopeptides, proteinaceous species with specific binding sites towards the trace metals, and free or bonded glycine amino acid.
Clause 42. The animal feed of any one of clauses 36-41, wherein the milled corn product is heavy steep water that comprises:
(i) a biomass sourced from an ethanol yeast fermentation, lactobacillus fermentation, or a combination of both;
(ii) about 28 wt % to about 42 wt % corn protein on a dry weight basis;
(iii) a phosphorous content between about 1.6 wt % and about 2.8 wt % and a sulfur content between about 0.3 wt % and about 0.8 wt % on dry weight basis;
(iv) a soluble carbohydrate content between about 12 wt % and about 24 wt % on dry weight basis; and
(v) an organic acid content-between about 16 wt % and about 32 wt % on dry weight basis.
Clause 43. The animal feed of any one of clauses 36-42, wherein the heavy steep water comprises one or more of free amino acids, peptides, oligopeptides, proteinaceous species with specific binding sites towards trace metals and free or bonded glycine amino acid.
Clause 44. The animal feed of any one of clauses 36-43, wherein the amount of trace metal is about 0.05 wt % to about 10 wt % of the nutritional composition on a dry weight basis.
Clause 45. The animal feed of any one of clauses 36-44, wherein up to 90 mol % of the trace metal is chelated or complexed.
Clause 46. The animal feed of any one of clauses 36-45, wherein the trace metal is uniformly distributed within the protein.
Clause 47. The animal feed of any one of clauses 36-46 that additionally comprises corn germ meal as a trace metal-protein carrier.
Clause 48. The animal feed of any one of clauses 36-47, wherein the animal feed is poultry feed.
Clause 49. The animal feed of any one of clauses 36-48, wherein the bioavailability of trace metal is at least 105%, preferably about 105% to about 130%, when compared to unchelated trace metal; and preferably wherein bioavailability of the trace metal is determined according to the slope ratio method relative to the bioavailability of trace metal salt using response parameters of weight gain, tibia ash concentration of the trace metal, and total trace metal in the tibia.
Clause 50. A method of feeding an animal comprising feeding the animal an animal feed comprising 0.0001 wt % to 0.8500 wt % of a nutritional composition, the nutritional composition comprising:
(i) one or more of trace metals selected from zinc, manganese, cobalt, copper, and chromium; and
(ii) a milled corn product comprising protein; wherein up to about 75 wt % of the trace metal is chelated or complexed within the milled corn product on a dry weight basis;
wherein the amount of trace metal is about 0.025 wt % to about 12 wt % of the nutritional composition product on a dry weight basis; and
the amount of protein is about 18 wt % to about 83 wt % of the nutritional composition on a dry weight basis.
Clause 51. The method of clause 50, wherein the amount of the nutritional composition in the animal feed product is 0.0030 wt % to 0.0300 wt %.
Clause 52. The method of clause 50 or clause 51, wherein the milled corn product is wet milled.
Clause 53. The method of any one of clauses 50-52, wherein the milled corn product comprises at least one of corn protein concentrate, corn protein isolate, steep water, gluten slurry, liquified gluten, and a fermented corn product.
Clause 54. The method of any one of clauses 50-53, wherein the milled corn product is corn protein concentrate that comprises:
(i) about 55 wt % to about 80 wt % corn protein on a dry weight basis;
(ii) a “L” color value between about 60 and about 80;
(iii) a phosphorous content between about 0.2 wt % and 0.5 wt % and a sulfur content between about 0.3 wt % and about 0.8 wt % on dry weight basis;
(iv) about 0.8 wt % and about 1.2 wt %, on dry weight basis; and
(v) a carbohydrate content between about 8 wt % and 21 wt % on dry weight basis.
Clause 55. The method of any one of clauses 50-54, wherein the corn protein concentrate comprises one or more of free amino acids, peptides, oligopeptides, proteinaceous species with specific binding sites towards the trace metals, and free or bonded glycine amino acid.
Clause 56. The method of any one of clauses 50-55, wherein the milled corn product is heavy steep water that comprises:
(i) a biomass sourced from an ethanol yeast fermentation, lactobacillus fermentation, or a combination of both;
(ii) about 28 wt % to about 42 wt % corn protein on a dry weight basis;
(iii) a phosphorous content between about 1.6 wt % and about 2.8 wt % and a sulfur content between about 0.3 wt % and about 0.8 wt % on dry weight basis;
(iv) a soluble carbohydrate content between about 12 wt % and about 24 wt % on dry weight basis; and
(v) an organic acid content-between about 16 wt % and about 32 wt % on dry weight basis.
Clause 57. The method of any one of clauses 50-56, wherein the heavy steep water comprises one or more of free amino acids, peptides, oligopeptides, proteinaceous species with specific binding sites towards trace metals and free or bonded glycine amino acid.
Clause 58. The method of any one of clauses 50-57, wherein the amount of trace metal is about 0.05 wt % to about 10 wt % of the nutritional composition on a dry weight basis.
Clause 59. The method of any one of clauses 50-58, wherein up to 90 mol % of the trace metal is chelated or complexed.
Clause 60. The method of any one of clauses 50-59, wherein the trace metal is uniformly distributed within the protein.
Clause 61. The method of any one of clauses 50-60 that additionally comprises corn germ meal as a trace metal-protein carrier.
Clause 62. The method of any one of clauses 50-61, wherein the animal is poultry.
Clause 63. The method of any one of clauses 50-62, wherein the bioavailability of trace metal is at least 105% when compared to unchelated trace metal; preferably wherein bioavailability of the trace metal is determined according to the slope ratio method relative to the bioavailability of trace metal salt using response parameters of weight gain, tibia ash concentration of the trace metal, and total trace metal in the tibia.
Clause 64. The method of any one of clauses 50-63, wherein the bioavailability of trace metal is about 105% to about 130% when compared to unchelated trace metal; preferably wherein bioavailability of the trace metal is determined according to the slope ratio method relative to the bioavailability of trace metal salt using response parameters of weight gain, tibia ash concentration of the trace metal, and total trace metal in the tibia.
Clause 65. A concentrate, premix, or top dress for animals comprising 0.0001 wt % to 0.8500 wt of nutritional composition comprising, the nutritional composition comprising:
(i) one or more of trace metals selected from zinc, manganese, cobalt, copper, and chromium; and
(ii) a milled corn product comprising protein; wherein up to 75 wt % of the trace metal is chelated or complexed within the milled corn product on a dry weight basis;
wherein the amount of trace metal is about 0.025 wt % to about 12 wt % of the nutritional composition product on a dry weight basis; and
the amount of protein is about 18 to about 83 wt % of the nutritional composition on a dry weight basis.
Clause 66. The concentrate, premix, or top dress of clause 65, wherein the amount of the nutritional composition in the concentrate, premix, or top dress is 0.0083 wt % to 50 wt % based on total weight of the concentrate, premix, or top dress.
Clause 67. The concentrate, premix, or top dress of clause 65 or clause 66, wherein the milled corn product is wet milled.
Clause 68. The concentrate, premix, or top dress of any one of clauses 65-67, wherein the milled corn product comprises at least one of corn protein concentrate, corn protein isolate, steep water, gluten slurry, liquified gluten, and a fermented corn product.
Clause 69. The concentrate, premix, or top dress of any one of clauses 65-68, wherein the milled corn product is corn protein concentrate that comprises:
(i) about 55 wt % to about 80 wt % corn protein on a dry weight basis;
(ii) a “L” color value between about 60 and about 80;
(iii) a phosphorous content between about 0.2 wt % and about 0.5 wt % and a sulfur content between about 0.3 wt % and about 0.8 wt % on dry weight basis;
(iv) about 0.8 wt % and about 1.2 wt %, on dry weight basis; and
(v) a carbohydrate content between about 8 wt % and about 21 wt % on dry weight basis.
Clause 70. The concentrate, premix, or top dress of any one of clauses 65-69, wherein the corn protein concentrate comprises one or more of free amino acids, peptides, oligopeptides, proteinaceous species with specific binding sites towards the trace metals, and free or bonded glycine amino acid.
Clause 71. The concentrate, premix, or top dress of any one of clauses 65-70, wherein the milled corn product is heavy steep water that comprises:
(i) a biomass sourced from an ethanol yeast fermentation, lactobacillus fermentation, or a combination of both;
(ii) about 28 wt % to about 42 wt % corn protein on a dry weight basis;
(iii) a phosphorous content between about 1.6 wt % and about 2.8 wt % and a sulfur content between about 0.3 wt % and about 0.8 wt % on dry weight basis;
(iv) a soluble carbohydrate content between about 12 wt % and about 24 wt % on dry weight basis; and
(v) an organic acid content-between about 16 wt % and about 32 wt % on dry weight basis.
Clause 72. The concentrate, premix, or top dress of any one of clauses 65-71, wherein the heavy steep water comprises one or more of free amino acids, peptides, oligopeptides, proteinaceous species with specific binding sites towards trace metals and free or bonded glycine amino acid.
Clause 73. The concentrate, premix, or top dress of any one of clauses 65-72, wherein the amount of trace metal is about 0.05 wt % to about 10 wt % of the nutritional composition on a dry weight basis.
Clause 74. The concentrate, premix, or top dress of any one of clauses 65-73, wherein up to about 90 mol % of the trace metal is chelated or complexed.
Clause 75. The concentrate, premix, or top dress of any one of clauses 65-74, wherein the trace metal is uniformly distributed within the protein.
Clause 76. The concentrate, premix, or top dress of any one of clauses 65-75, wherein the bioavailability of trace metal is about 105% to about 130% when compared to unchelated trace metal.
Clause 77. The concentrate, premix, or top dress animals of any one of clauses 65-76 that additionally comprises corn germ meal as a trace metal-protein carrier.
Clause 78. The concentrate, premix, or top dress of any one of clauses 65-77, wherein the animal feed is poultry feed.
Clause 79. The concentrate, premix, or top dress of any one of clauses 65-78, wherein the bioavailability of trace metal is at least about 105% when compared to unchelated trace metal; preferably wherein bioavailability of the trace metal is determined according to the slope ratio method relative to the bioavailability of trace metal salt using response parameters of weight gain, tibia ash concentration of the trace metal, and total trace metal in the tibia.
Clause 80. A complete feed for animals comprising a concentrate, premix, or top dress of any one of clauses 65-79.
Clause 81. The complete feed of clause 80, comprising the concentrate, wherein the amount of concentrate is less than about 50 wt % of the complete feed.
Clause 82. The complete feed of clause 80 or clause 81, comprising the concentrate, wherein the amount of concentrate in is about 5 wt % to about 40 wt % of the complete feed.
Clause 83. The complete feed of any one of clauses 80-82, comprising the premix, wherein the amount of premix is less than about 2 wt % of the complete feed.
Clause 84. The complete feed of any one of clauses 80-83, comprising the premix, wherein the amount of premix is about 0.25 wt % to about 1 wt % of the complete feed.
Clause 85. The complete feed of any one of clauses 80-84, comprising the top dress, wherein the amount of top dress is less than or equal to about 1 wt % of the complete feed.
Clause 86. The complete feed of any one of clauses 80-85, comprising the top dress, wherein the amount of top dress is about 0.25 wt % to about 1 wt % of the complete feed.
Clause 87. The complete feed of any one of clauses 80-86, wherein the bioavailability of trace metal is at least about 105% when compared to unchelated trace metal; preferably wherein bioavailability of the trace metal is determined according to the slope ratio method relative to the bioavailability of trace metal salt using response parameters of weight gain, tibia ash concentration of the trace metal, and total trace metal in the tibia.
Clause 88. A method of making a complete feed, the method comprising:
combining the concentrate, premix, or top dress of clause 65-79 with a base animal feed to form the complete feed.
Clause 89. A method of improving bioavailability of trace metal nutrients in an animal feed, the method comprising adding 0.0001 wt % to 0.8500 wt % of a nutritional composition to the animal feed, the nutritional composition comprising:
(i) one or more of trace metals selected from zinc, manganese, cobalt, copper, and chromium; and
(ii) a milled corn product comprising protein; wherein up to about 75 wt % of the trace metal is chelated or complexed within the milled corn product on a dry weight basis;
wherein the amount of trace metal is about 0.025 wt % to about 12 wt % of the nutritional composition product on a dry weight basis; and
the amount of protein is about 18 to about 83 wt % of the nutritional composition on a dry weight basis.
Clause 90. The method of clause 89, wherein the bioavailability of trace metal is at least about 105% when compared to unchelated trace metal; preferably wherein bioavailability of the trace metal is determined according to the slope ratio method relative to the bioavailability of trace metal salt using response parameters of weight gain, tibia ash concentration of the trace metal, and total trace metal in the tibia.
Clause 91. Use of a nutritional composition to improve bioavailability of trace metals in an animal feed comprising adding 0.0001 wt % to 0.8500 wt % of a nutritional composition to the animal feed, the nutritional composition comprising:
(i) one or more of trace metals selected from zinc, manganese, cobalt, copper, and chromium; and
(ii) a milled corn product comprising protein; wherein up to about 75 wt % of the trace metal is chelated or complexed within the milled corn product on a dry weight basis;
wherein the amount of trace metal is about 0.025 wt % to about 12 wt % of the nutritional composition product on a dry weight basis; and
   the amount of protein is about 18 wt % to about 83 wt % of the nutritional composition on a dry weight basis.
Clause 92. The use of a nutritional composition according to clause 91, wherein the nutritional composition is a nutritional composition according to any one of clauses 65-79.

Each of the non-limiting aspects above can stand on its own or can be combined in various permutations or combinations with one or more of the other aspects or other subject matter described in this document. While certain aspects have been illustrated and described a person with ordinary skill in the art, after reading the foregoing specification can effect changes, substitutions of equivalents and other types of alterations to the present technology as set forth herein. Each aspect described above can also have included or incorporated therewith such variations or aspects as disclosed in regard to any or all of the other aspects and aspects.

The present technology is also not to be limited in terms of the particular aspects described herein, which are intended as single illustrations. Many modifications and variations of this present technology can be made without departing from its spirit and scope, as will be apparent to those skilled in the art from the foregoing descriptions. Such modifications and variations are intended to fall within the scope of the appended claims. It is to be understood that this present technology is not limited to particular methods, reagents, compounds, or compositions, which can, of course, vary. It is also to be understood that the terminology used herein is for the purpose of describing particular aspects only, and is not intended to be limiting. Thus, it is intended that the specification be considered as exemplary only with the breadth, scope and spirit of the present technology indicated only by the appended claims, definitions therein and any equivalents thereof.

The aspects, illustratively described herein may suitably be practiced in the absence of any element or elements, limitation or limitations, not specifically disclosed herein. Thus, for example, the terms “comprising,” “including,” “containing,” etc. shall be read expansively and without limitations. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

1. An animal feed comprising 0.0001 wt % to 0.8500 wt % of a nutritional composition, the nutritional composition comprising:
(i) one or more trace metals selected from zinc, manganese, cobalt, copper, and chromium; and
(ii) a milled corn product comprising protein, preferably the milled corn product is wet milled; wherein up to about 75 wt % of the trace metal is chelated or complexed within the milled corn production a dry weight basis;
wherein the amount of trace metal is about 0.025 wt % to about 12 wt % of the nutritional composition product on a dry weight basis; and
the amount of protein is about 18 wt % to about 83 wt % of the nutritional composition on a dry weight basis.

2. The animal feed of claim 1, wherein the milled corn product comprises at least one of corn protein concentrate, corn protein isolate, steep water, gluten slurry, liquified gluten, and a fermented corn product.

3. The animal feed of claim 1, wherein the milled corn product is corn protein concentrate that comprises:
(i) about 55 wt % to about 80 wt % corn protein on a dry weight basis;
(ii) a “L” color value between about 60 and about 80;
(iii) a phosphorous content between about 0.2 wt % and about 0.5 wt % and a sulfur content between about 0.3 wt % and about 0.8 wt % on dry weight basis;
(iv) about 0.8 wt % and about 1.2 wt %, on dry weight basis; and
(v) a carbohydrate content between about 8 wt % and about 21 wt % on dry weight basis.

4. The animal feed of claim 1, wherein the milled corn product is heavy steep water that comprises:
(i) a biomass sourced from an ethanol yeast fermentation, lactobacillus fermentation, or a combination of both;
(ii) about 28 wt % to about 42 wt % corn protein on a dry weight basis;
(iii) a phosphorous content between about 1.6 wt % and about 2.8 wt % and a sulfur content between about 0.3 wt % and about 0.8 wt % on dry weight basis;
(iv) a soluble carbohydrate content between about 12 wt % and about 24 wt % on dry weight basis; and
(v) an organic acid content-between about 16 wt % and about 32 wt % on dry weight basis.

5. The animal feed of claim 4, wherein the heavy steep water comprises one or more of free amino acids, peptides, oligopeptides, proteinaceous species with specific binding sites towards trace metals and free or bonded glycine amino acid.

6. The animal feed of claim 1, wherein the amount of trace metal is about 0.05 wt % to about 10 wt % of the nutritional composition on a dry weight basis.

7. The animal feed of claim 1, wherein up to about 90 mol % of the trace metal is chelated or complexed.

8. The animal feed of claim 1, wherein the trace metal is uniformly distributed within the protein.

9. The animal feed of claim 1 wherein the animal feed is poultry feed.

10. The animal feed of claim 1, wherein the animal feed comprises 0.0030 wt % to 0.0300 wt % of the nutritional composition based on a dry weight basis of the animal feed.

11. The animal feed of claim 1, wherein the bioavailability of trace metal is at least about 105% when compared to unchelated trace metal.

12. The animal feed of claim 11, wherein bioavailability of the trace metal, preferably Zn, is determined according to the slope ratio method relative to the bioavailability of trace metal sulfate, preferably ZnSO₄, using response parameters of weight gain, tibia ash concentration of the trace metal.

13. A method of feeding an animal comprising feeding the animal an animal feed comprising 0.0001 wt % to 0.8500 wt % of a nutritional composition, the nutritional composition comprising:
(i) one or more of trace metals selected from zinc, manganese, cobalt, copper, and chromium; and
(ii) a milled corn product comprising protein; wherein up to about 75 wt % of the trace metal is chelated or complexed within the milled corn product on a dry weight basis;
wherein the amount of trace metal is about 0.025 wt % to about 12 wt % of the nutritional composition product on a dry weight basis; and
the amount of protein is about 18 to about 83 wt % of the nutritional composition on a dry weight basis.
